(19) United States
(12) Patent Application Publication
(10) Pub. No.: US 2024/0023195 A1
(43) Pub. Date: Jan. 18, 2024

(54) METHOD AND APPARATUS FOR NETWORK SAVING ENERGY IN COMMUNICATION SYSTEMS

(71) Applicant: ELECTRONICS AND TELECOMMUNICATIONS RESEARCH INSTITUTE, Daejeon (KR)

(72) Inventor: Jae Heung KIM, Daejeon (KR)

(73) Assignee: ELECTRONICS AND TELECOMMUNICATIONS RESEARCH INSTITUTE, Daejeon (KR)

(21) Appl. No.: 18/350,964

(22) Filed: Jul. 12, 2023

(30) Foreign Application Priority Data
Jul. 12, 2022 (KR) 10-2022-0085822
Aug. 4, 2022 (KR) 10-2022-0097430
Sep. 23, 2022 (KR) 10-2022-0120487
Feb. 8, 2023 (KR) 10-2023-0017042

(51) Int. Cl. H04W 76/28; H04W 72/232; H04W 72/12

(52) U.S. Cl. CPC H04W 76/28; H04W 72/232; H04W 72/12

(57) ABSTRACT

A method of a base station may comprise: transmitting discontinuous transmission (DTX) configuration information for a DTX operation to a terminal; transmitting discontinuous reception (DRX) configuration information for a DRX operation to the terminal; and transmitting information indicating activation of at least one of the DTX operation and the DRX operation to the terminal, wherein the DTX operation and the DRX operation are configured separately.

### CROSS-REFERENCE TO RELATED APPLICATIONS

This application claims priority to Korean Patent Applications No. 10-2022-0085822, filed on Jul. 12, 2022, No. 10-2022-0097430, filed on Aug. 4, 2022, No. 10-2022-0120487, filed on Sep. 23, 2022, and No. 10-2023-0017042, filed on Feb. 8, 2023, with the Korean Intellectual Property Office (KIPO), the entire contents of which are hereby incorporated by reference.

### BACKGROUND

### 1. Technical Field

Exemplary embodiments of the present disclosure relate to a network energy saving technique in a communication system, and more specifically, to a network energy saving technique in a communication system, in which state(s) of terminal(s) within a service coverage and a service quality for the terminal(s) are identified, and a network energy saving operation is performed according to the identified state(s) and service quality of the terminal(s).

### 2. Related Art

In order to cope with the explosive increase in wireless data, a mobile communication system can support a wide system bandwidth. In order to support a wide system bandwidth, a 6 GHz to 90 GHz band may be considered as a transmission frequency band in a mobile communication system. In such a high frequency band, performance degradation of a received signal may occur due to path losses and reflections of radio waves. In this situation, a method of utilizing radio access points to improve terminal performance at a base station (or cell) boundary may be considered. The radio access point may refer to a transmission and reception point (TRP), remote radio head (RRH), relay, or repeater.

In a mobile communication system supporting a millimeter wave band (e.g., 6 GHz to GHz band), use of a function split scheme, carrier aggregation scheme, dual connectivity scheme, and/or duplication transmission scheme may be considered rather than a method of deploying small base stations each implementing all radio protocol functions. In other words, a method of constructing a mobile communication system using a plurality of radio access points instead of small base stations may be considered. When the function split scheme is used, functions (e.g., radio protocol functions) of a base station may be processed as being split into a plurality of remote radio transmission/reception blocks and one centralized baseband processing function block.

In a mobile communication network in which various types of base stations (or cells) including small cells and radio access points are widely deployed, the energy consumption of the mobile communication network may rapidly increase in order to provide a large-capacity service with mobility function support to terminals.

### SUMMARY

Exemplary embodiments of the present disclosure are directed to providing a method and an apparatus for network energy saving in a communication system, in which state(s) of terminal(s) within a service coverage and a service quality of the terminal(s) are identified, and a network energy saving operation is performed according to the identified state(s) and service quality of the terminal(s).

According to a first exemplary embodiment of the present disclosure, a method of a base station may comprise: transmitting discontinuous transmission (DTX) configuration information for a DTX operation to a terminal; transmitting discontinuous reception (DRX) configuration information for a DRX operation to the terminal; and transmitting information indicating activation of at least one of the DTX operation and the DRX operation to the terminal, wherein the DTX operation and the DRX operation are configured separately.

The DTX configuration information may include at least one of information on a cycle of the DTX operation, configuration information of an on-duration of the DTX operation, information indicating a time at which the DTX operation starts, information on a timer for performing the DTX operation, allocation information of an uplink channel configured for reception from the terminal during performing the DTX operation, or information indicating a time at which the DTX operation is released.

The DRX configuration information may include at least one of information on a cycle of the DRX operation, configuration information of an on-duration of the DRX operation, information indicating a time at which the DRX operation starts, information on a timer for performing the DRX operation, allocation information of an uplink channel configured for reception from the terminal during performing the DRX operation, or information indicating a time at which the DRX operation is released.

The DTX configuration information and the DRX configuration information may be included in a radio resource control (RRC) message(s) transmitted to the terminal.

The information indicating activation may be included in a medium access control (MAC) control element (CE) or downlink control information (DCI) transmitted to the terminal.

The MAC CE or the DCI may further include information on a start time of the DTX operation or information on a start time of the DRX operation.

The start time of each of the DTX operation and the DRX operation may be set in units of frames, slots, mini-slots, or symbols.

The information on the start time of the DTX operation may be an offset between a reception time of the information indicating activation of the DTX operation and the start time of the DTX operation, and the information on the start time of the DRX operation may be an offset between a reception time of the information indicating activation of the DRX operation and the start time of the DRX operation.

The method may further comprise: transmitting information indicating deactivation of at least one of an activated DTX operation or an activated DRX operation to the terminal, wherein the information indicating deactivation is included in a MAC CE or DCI transmitted to the terminal.

The method may further comprise: identifying a state of a service coverage of the base station where the terminal is located, wherein at least one of the DTX operation or the DRX operation, which is activated for the terminal, is determined based on the state of the service coverage.

The state of the service coverage may be identified as at least one of a number of terminals located in the service coverage or a quality of a service provided to the terminals within the service coverage.

The method may further comprise: re-identifying a state of the service coverage; and transmitting information indicating deactivation of at least one of an activated DTX operation and an activated DRX operation to the terminal based on the re-identified state of the service coverage.

The method may further comprise: transmitting a message including camping restriction information, wherein the camping restriction information indicates whether the base station supports a network energy saving (NES) function, and when the base station supports the NES function, the base station may perform at least one of the DTX operation or the DRX operation.

The method may further comprise: restricting camping of at least one terminal when the at least one terminal satisfying the camping restriction information requests camping.

According to a second exemplary embodiment of the present disclosure, a method of a terminal may comprise: receiving discontinuous transmission (DTX) configuration information for a DTX operation from a base station; receiving discontinuous reception (DRX) configuration information for a DRX operation from the base station; and receiving information indicating activation of at least one of the DTX operation and the DRX operation from the base station, wherein the DTX operation and the DRX operation are configured separately.

The DTX configuration information may include at least one of information on a cycle of the DTX operation, configuration information of an on-duration of the DTX operation, information indicating a time at which the DTX operation starts, information on a timer for performing the DTX operation, allocation information of an uplink channel configured for transmission to the base station during performing the DTX operation, or information indicating a time at which the DTX operation is released.

The DRX configuration information may include at least one of information on a cycle of the DRX operation, configuration information of an on-duration of the DRX operation, information indicating a time at which the DRX operation starts, information on a timer for performing the DRX operation, allocation information of an uplink channel configured for transmission to the base station during performing the DRX operation, or information indicating a time at which the DRX operation is released.

The DTX configuration information and the DRX configuration information may be included in a radio resource control (RRC) message(s) received from the base station.

The information indicating activation may be included in a medium access control (MAC) control element (CE) or downlink control information (DCI) transmitted to the terminal.

According to the present disclosure, a network node may perform a transmission-off operation in consideration of state(s) of terminal(s) within a service coverage, a quality of service provided to the terminal(s), and/or the like. In addition, according to the present disclosure, the network node may perform a transmission-off operation when an instruction to suspend transmission is received from a central control unit. In addition, according to the present disclosure, the network node may perform a transmission-off operation when notifying the terminal(s) within the service coverage that transmission is suspended and/or transmission is scheduled to be suspended. Accordingly, according to the present disclosure, the network node can save energy by performing the transmission-off operation.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of an apparatus.

FIG. 3 is a conceptual diagram illustrating a first exemplary embodiment of operation states of a terminal in a communication system.

FIG. 4 is a conceptual diagram illustrating a first exemplary embodiment of a method for configuring bandwidth parts (BWPs) in a communication system.

FIG. 5 is a conceptual diagram illustrating a second exemplary embodiment of a communication system.

FIG. 6 is a conceptual diagram illustrating a first exemplary embodiment of a method of providing a service using a plurality of radio access points in a communication system.

FIGS. 7A and 7B are sequence charts illustrating a first exemplary embodiment of a NES method in a communication system.

FIGS. 8A and 8B are sequence charts illustrating a second exemplary embodiment of a NES method in a communication system.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. ‘Configuration of information element(s) (e.g., parameter(s))’ may mean that the corresponding information element(s) are signaled. ‘Configuration of a resource (e.g., resource region)’ may mean that configuration information of the corresponding resource is signaled. The signaling may be performed based on at least one of system information (SI) signaling (e.g., transmission of system information block (SIB) and/or master information block (MIB)), RRC signaling (e.g., transmission of RRC parameters and/or higher layer parameters), MAC control element (CE) signaling, PHY signaling (e.g., transmission of downlink control information (DCI), uplink control information (UCI), and/or sidelink control information (SCI)), or a combination thereof.

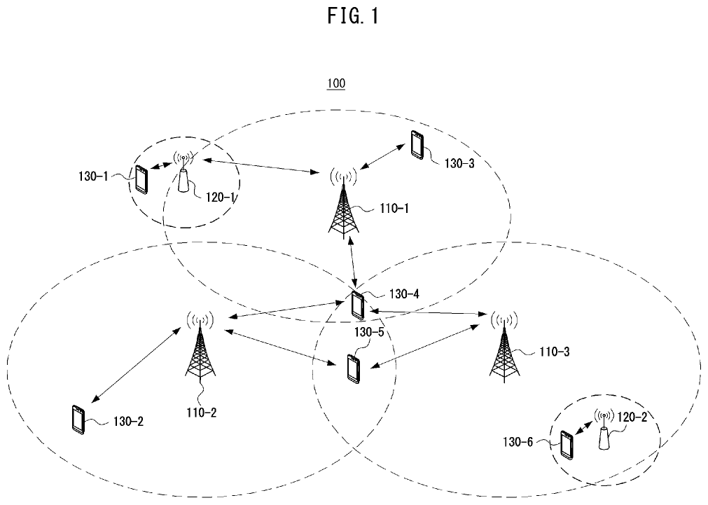

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows.

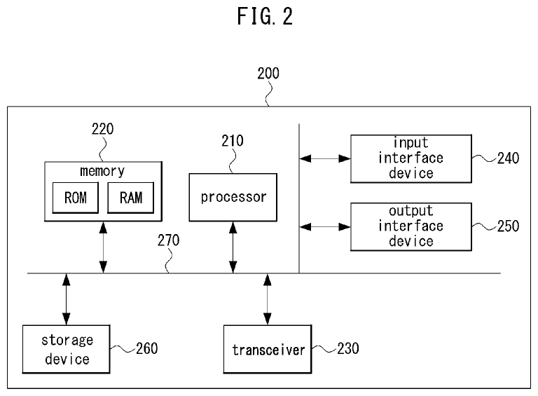

FIG. 2 is a block diagram illustrating a first exemplary embodiment of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to operations of the plurality of base stations 110-1, 110-2, 110-3, 120-1, and 120-2, operations supported by the plurality of base stations 110-1, 110-2, 110-3, 120-1, and 120-2, or the like. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

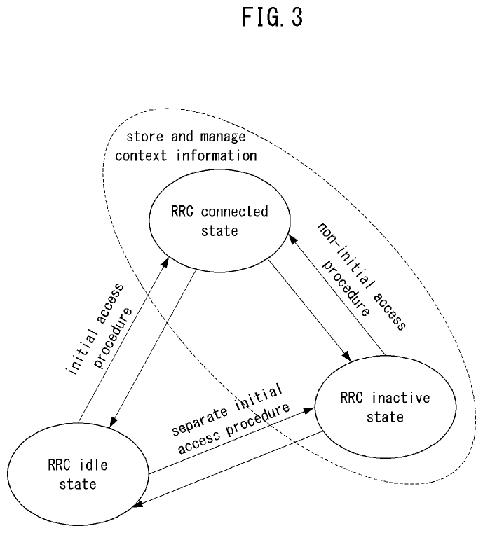

FIG. 3 is a conceptual diagram illustrating a first exemplary embodiment of operation states of a terminal in a communication system.

Referring to FIG. 3, in a radio resource control (RRC) layer of the communication system, states (e.g., operation states) of a terminal may be classified into an RRC connected state, RRC inactive state, and RRC idle state. When the terminal operates in the RRC connected state or the RRC inactive state, a base station of a radio access network (RAN) and the terminal may store and/or manage RRC connection configuration information, RRC context information, or access stratum (AS) context information of the terminal.

In the RRC connected state, the terminal may receive allocation information of physical layer control channels and/or reference signals necessary for maintaining RRC connection configuration and/or transmitting and receiving packets (e.g., data). The reference signal may be a reference signal for demodulating data, a reference signal for measuring a channel quality, and/or a reference signal for beamforming. The terminal in the RRC connected state may be able to transmit and receive packets (e.g., data) without additional delay. In the present disclosure, the packet may refer to data.

In the RRC inactive state, the terminal may perform a mobility management function corresponding to the RRC idle state. Although the terminal in the RRC inactive state is in a state of being connected to the base station, a data bearer for transmitting and receiving packets may not be configured in the terminal in the RRC inactive state, and functions such as the MAC layer may be inactivated in the terminal in the RRC inactive state. In order to transmit data, the terminal in the RRC inactive state may transition to the RRC connected state by performing a non-initial access procedure. Alternatively, the terminal in the RRC inactive state may transmit limited data allowed in the RRC inactive state. The limited data may be data having a limited size, data having a limited quality of service, and/or data belonging to a limited type of service.

From the perspective of the radio access network, a connection configured between the terminal in the RRC idle state and the base station may not exist. Connection configuration information and/or context information (e.g., RRC context information, AS context information) for the terminal in the RRC idle state may not be stored in the base station and/or a control function block of the radio access network. The terminal in the RRC idle state may perform an initial access procedure to transition to the RRC connected state. Although the terminal in the RRC idle state performs an initial access procedure to transition to the RRC connected state, the state of the terminal may transition from the RRC idle state to the RRC inactive state according to determination of the base station.

The terminal in the RRC idle state may transition to the RRC inactive state by performing an initial access procedure or a separate access procedure defined for transition to the RRC inactive state. When a limited service is provided to the terminal, the operation state of the terminal may transition from the RRC idle state to the RRC inactive state. Alternatively, the operation state of the terminal may transition from the RRC idle state to the RRC inactive state according to capability of the terminal.

The base station and/or the control function block of the radio access network may configure condition(s) by which the terminal can transition to the RRC inactive state in consideration of one or more of the type, capability, and/or service (e.g., service currently being provided, service to be provided) of the terminal, and may control the transition operation to the RRC inactive state based on the configured condition(s). When the base station allows transition to the RRC inactive state or when it is configured to be able to transition to the RRC inactive state, the operation state of the terminal may transition from the RRC connected state or the RRC idle state to the RRC inactive state.

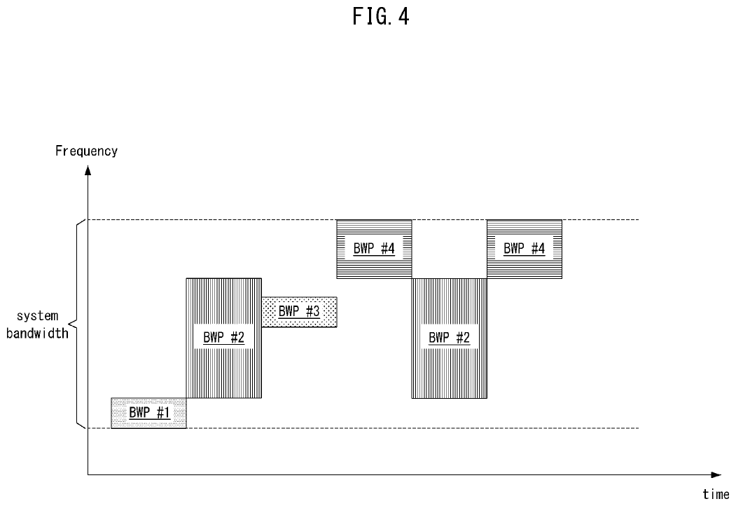

FIG. 4 is a conceptual diagram illustrating a first exemplary embodiment of a method for configuring bandwidth parts (BWPs) in a communication system.

Referring to FIG. 4, a plurality of bandwidth parts (e.g., BWPs #1 to #4) may be configured within a system bandwidth of the base station. The BWPs #1 to #4 may be configured not to be larger than the system bandwidth of the base station. The bandwidths of the BWPs #1 to #4 may be different, and different subcarrier spacings (SCSs) may be applied to the BWPs #1 to #4. For example, the bandwidth of the BWP #1 may be 10 MHz, and the BWP #1 may have a 15 kHz SCS. The bandwidth of the BWP #2 may be 40 MHz, and the BWP #2 may have a 15 kHz SCS. The bandwidth of the BWP #3 may be 10 MHz, and the BWP #3 may have a 30 kHz SCS. The bandwidth of the BWP #4 may be 20 MHz, and the BWP #4 may have a 60 kHz SCS.

The BWPs may be classified into an initial BWP (e.g., first BWP), an active BWP (e.g., activated BWP), and a default BWP. The terminal may perform an initial access procedure (e.g., access procedure) with the base station in the initial BWP. One or more BWPs may be configured through an RRC connection configuration message, and one BWP among the one or more BWPs may be configured as the active BWP. Each of the terminal and the base station may transmit and receive packets in the active BWP among the configured BWPs. Therefore, the terminal may perform a monitoring operation on control channels for packet transmission and reception in the active BWP.

The terminal may switch the operating BWP from the initial BWP to the active BWP or the default BWP. Alternatively, the terminal may switch the operating BWP from the active BWP to the initial BWP or the default BWP. The BWP switching operation may be performed based on an indication of the base station or a timer. The base station may transmit information indicating the BWP switching to the terminal using one or more of an RRC message, a MAC message (e.g., MAC control element (CE)), and a PHY message (e.g., DCI). The terminal may receive the information indicating the BWP switching from the base station, and may switch the operating BWP of the terminal to a BWP indicated by the received information.

When a random access (RA) resource is not configured in the active uplink (UL) BWP in the NR communication system, the terminal may switch the operating BWP of the terminal from the active UL BWP to the initial UL BWP in order to perform a random access procedure. The operating BWP may be a BWP in which the terminal performs communication (e.g., transmission and reception operation of a signal and/or channel).

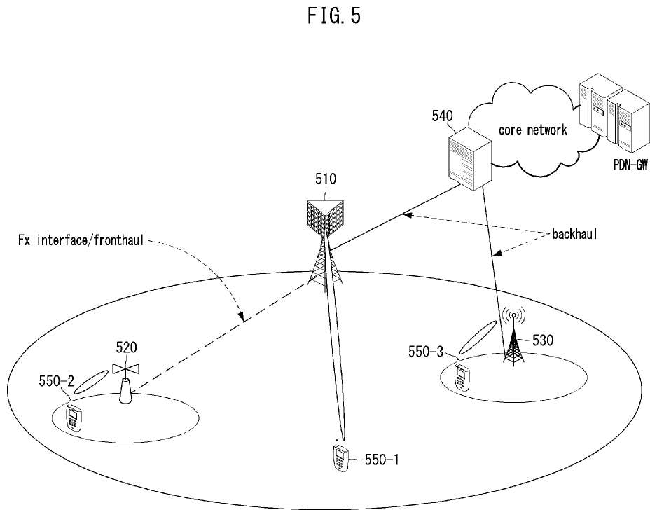

FIG. 5 is a conceptual diagram illustrating a second exemplary embodiment of a communication system.

Referring to FIG. 5, a communication system may include a core network and an access network. The core network supporting the 4G communication may include an MME, S-GW, P-GW, and the like. A function block supporting the S-GW and the MME may be referred to as an S-GW/MME 540. The core network supporting the 5G communication may include an AMF, UPF, PDN-GW, and the like. A function block supporting the UPF and the AMF may be referred to as a UPF/AMF 540. The access network may include a base station 510, radio access point 520, small base station 530, and terminals 550-1, 550-2, and 550-3. The base station 510 may mean a macro base station. The base station 510 and/or the small base station 530 may be connected to an end node of the core network through a backhaul. The end node may be the S-GW, UPF, MME, AMF, or the like.

The function split scheme may be applied to the base station 510 and the small base station 530. In this case, each of the base station 510 and the small base station 530 may include one central unit (CU) and one or more distributed units (DUs). The CU may be a logical node that performs functions of an RRC layer, service data application protocol (SDAP) layer, and/or packet data convergence protocol (PDCP) layer. The CU may control operations of one or more DUs. The CU may be connected to an end node of the core network using an S1 interface-based backhaul or an NG interface-based backhaul. The S1 interface-based backhaul may refer to a backhaul in the 4G communication system, and the NG interface-based backhaul may refer to a backhaul in the 5G communication system.

The DU may be a logical node that performs functions of a radio link control (RLC) layer, MAC layer, and/or PDCP layer. The DU may support one or more cells. The DU may be connected to the CU in a wired or wireless manner using an F1 interface. When a wireless scheme is used, a connection between the DU and the CU may be configured in an integrated access and backhaul (IAB) scheme.

Each of the base station 510 and the small base station 530 may be connected to the radio access point 520 in a wired or wireless manner using an Fx interface (or fronthaul). In the present disclosure, the base station (e.g., macro base station, small base station) may refer to a cell, DU, and/or the like. The radio access point may refer to a transmission and reception point (TRP), remote radio head (RRH), relay, or repeater. The TRP may perform at least one of a downlink transmission function and an uplink reception function. The radio access point 520 may perform only radio frequency (RF) functions.

Alternatively, the radio access point 520 may perform RF functions and some functions of the DU (e.g., some functions of a physical (PHY) layer and/or the MAC layer). Some functions of the DU, which are supported by the radio access point 520, may include lower functions of the PHY layer, functions of the PHY layer, and/or lower functions of the MAC layer. The Fx interface between the base station 510 or 530 and the radio access point 520 may be defined differently depending on the function(s) supported by the radio access point 520.

Each of the radio access point 520 of FIG. 5 and the base stations 110-1, 110-2, 110-3, 120-1, 120-2, 510, and 530 of FIGS. 1 and 5 may support OFDM, OFDMA, SC-FDMA, or NOMA-based downlink communication and/or uplink communication. Each of the radio access point 520 and the base stations 110-1, 110-2, 110-3, 120-1, 120-2, 510, and 530 may support beamforming functions using an antenna array in a transmission carrier of a millimeter wave band. In this case, a service through each beam may be provided without interference between beams within the base station. One beam may provide services for a plurality of terminals.

Each of the radio access point 520 and the plurality of base stations 110-1, 110-2, 110-3, 120-1, 120-2, 510, and 530 may perform MIMO transmission (e.g., single user (SU)-MIMO, multi user (MU)-MIMO, massive MIMO, etc.), coordinated multipoint (CoMP) transmission, carrier aggregation (CA) transmission, transmission in an unlicensed band, device-to-device (D2D) communication (or proximity services (ProSe), sidelink communication), and/or the like. Here, each of the plurality of terminals 130-1, 130-2, 130-3, 130-4, 130-5, 130-6, 550-1, 550-2, and 550-3 may perform operations corresponding to operations of the radio access point 520 and/or the plurality of base stations 110-1, 110-2, 110-3, 120-1, 120-2, 510, and 530 and/or operations supported by the radio access point 520 and/or the plurality of base stations 110-1, 110-2, 110-3, 120-1, 120-2, 510, and 530. For example, the second base station 110-2 may transmit a signal to the fourth terminal 130-4 based on the SU-MIMO scheme, and the fourth terminal 130-4 may receive the signal from the second base station 110-2 based on the SU-MIMO scheme. Alternatively, the second base station 110-2 may transmit signals to the fourth terminal 130-4 and the fifth terminal 130-5 based on the MU-MIMO scheme, and each of the fourth terminal 130-4 and the fifth terminal 130-5 may receive the signal from the second base station 110-2 based on the MU-MIMO scheme.

The first base station 110-1, the second base station 110-2, and the third base station 110-3 may transmit a signal to the fourth terminal 130-4 based on the CoMP scheme, and the fourth terminal 130-4 may receive the signal from the first base station 110-1, the second base station 110-2, and the third base station 110-3 based on the CoMP scheme. Each of the plurality of base stations 110-1, 110-2, 110-3, 120-1, and 120-2 may transmit and receive signals with the terminals 130-1, 130-2, 130-3, 130-4, 130-5, and 130-6 belonging to its own cell coverage based on the CA scheme. Each of the first base station 110-1, the second base station 110-2, and the third base station 110-3 may coordinate D2D communication between the fourth terminal 130-4 and the fifth terminal 130-5, and the fourth terminal 130-4 and the fifth terminal 130-5 may perform the D2D communication according to coordination of the second base station 110-2 and the third base station 110-3, respectively.

Hereinafter, operation methods of a communication node in a communication system will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the communication system, the UPF (or, S-GW) may refer to an end communication node of the core network that exchanges packets (e.g., control information, data) with the base station. In the communication system, the AMF (or, MME) may refer to a communication node in the core network, which performs control functions in a radio access section (or, interface) of the terminal. Here, each of the backhaul link, fronthaul link, Xhaul link, DU, CU, BBU block, S-GW, MME, AMF, and UPF may be referred to as a different term according to a function of a communication protocol depending on a radio access technology (RAT) or a constituent function of the core network.

In order to perform a mobility support function and a radio resource management function, the base station may transmit a synchronization signal (e.g., synchronization signal/physical broadcast channel (SS/PBCH) block or synchronization signal block (SSB)) and/or a reference signal. In order to support multiple numerologies, frame formats supporting symbols having different lengths may be configured. In this case, the terminal may perform a monitoring operation on the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication system is configured, and/or a frame format applied to radio resources in which a synchronization symbol burst capable of identifying a cell in the NR communication system is transmitted.

The frame format may refer to information of configuration parameters (e.g., values of the configuration parameters, offset, index, identifier, range, periodicity, interval, duration, etc.) for a subcarrier spacing, control channel (e.g., CORESET), symbol, slot, and/or reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the base station 510 may transmit a synchronization signal and/or a reference signal so that a terminal located within its service coverage can discover the base station 510 to perform downlink synchronization maintenance, beam configuration, or link monitoring operations. The terminal 550-1 connected to the base station 510 (e.g., serving base station) may receive physical layer radio resource configuration information for connection configuration and radio resource management from the base station 510.

The physical layer radio resource configuration information may mean configuration parameters included in RRC control messages of the LTE communication system or the NR communication system. For example, the resource configuration information may include PhysicalConfigDedicated, PhysicalCellGroupConfig, PDCCH-Config(Common), PDSCH-Config(Common), PDCCH-ConfigSIB1, ConfigCommon, PUCCH-Config(Common), PUSCH-Config(Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of the base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, slot, and subframe that exist within one radio frame (e.g., a frame of 10 ms) may be configured differently.
Configuration information of transmission a frequency and a frame format of a base station
   Transmission frequency configuration information: information on all transmission carriers (i.e., cell-specific transmission frequency) in the base station, information on bandwidth parts (BWPs) in the base station, information on a transmission reference time or time difference between transmission frequencies of the base station (e.g., a transmission periodicity or offset parameter indicating the transmission reference time (or time difference) of the synchronization signal), etc.
   Frame format configuration information: configuration parameters of a mini-slot, slot, and subframe having a different symbol length according to a subcarrier spacing
Configuration information of a downlink reference signal (e.g., channel state information-reference signal (CSI-RS), common reference signal (Common-RS), etc.)
   Configuration parameters such as a transmission periodicity, transmission position, code sequence, or masking (or scrambling) sequence for a reference signal, which are commonly applied within the coverage of the base station (or beam).
Configuration information of an uplink control signal
   Configuration parameters such as a sounding reference signal (SRS), uplink beam sweeping (or beam monitoring) reference signal, uplink grant-free radio resources (or, preambles), etc.
Configuration information of a physical downlink control channel (e.g., PDCCH)
   Configuration parameters such as a reference signal for PDCCH demodulation, beam common reference signal (e.g., reference signal that can be received by all terminals within a beam coverage), beam sweeping (or beam monitoring) reference signal, reference signal for channel estimation, etc.
Configuration information of a physical uplink control channel (e.g., PUCCH)
Scheduling request signal configuration information
Configuration information for a feedback (acknowledgement (ACK) or negative ACK (NACK)) transmission resource in a hybrid automatic repeat request (HARQ) procedure
Number of antenna ports, antenna array information, beam configuration or beam index mapping information for application of beamforming techniques
Configuration information of a downlink signal and/or an uplink signal (or uplink access channel resource) for beam sweeping (or beam monitoring)
Configuration information of parameters for beam configuration, beam recovery, beam reconfiguration, or radio link re-establishment operation, beam change operation within the same base station, reception signal of a beam triggering handover execution to another base station, timers controlling the above-described operations, etc.

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the present disclosure, ‘Resource-Config information’ may be a control message including one or more parameters of the physical layer radio resource configuration information. In addition, the ‘Resource-Config information’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group). A terminal group may include one or more terminals.

The configuration information included in the ‘Resource-Config information’ may be transmitted through one control message or different control messages according to the attributes of the configuration information. The beam index information may not express the index of the transmission beam and the index of the reception beam explicitly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station. For example, when a communication service is provided using beam configuration (e.g., beam pairing) between the base station and the terminal, the terminal may perform a search operation or a monitoring operation of a radio channel by using a synchronization signal (e.g., SS/PBCH block) and/or a reference signal (e.g., CSI-RS) of a beam configured with the base station, or a beam that can be received. Here, the expression that a communication service is provided through a beam may mean that a packet is transmitted and received through an active beam among one or more configured beams. In the NR communication system, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from system information or common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, procedure for recovering a radio link, procedure for detecting (or declaring) a radio link failure, and procedure for re-establishing a radio link according to the RLM operation may be performed by functions of a layer 1 (e.g., physical layer), a layer 2 (e.g., MAC layer, RLC layer, PDCP layer, etc.), and/or a layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, beam common reference signal, or terminal (or terminal group) specific reference signal (e.g., dedicated reference signal allocated to a terminal (or terminal group)). Here, the common reference signal may be used for channel estimation operations of all terminals located within the corresponding base station or beam coverage (or service area). The dedicated reference signal may be used for a channel estimation operation of a specific terminal or a specific terminal group located within the base station or beam coverage.

Accordingly, when the base station or the beam (e.g., configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication system may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. In a handover procedure, synchronization reconfiguration procedure, or connection reconfiguration procedure, the base station may transmit a dedicated control message including the configuration information of the common reference signal to the terminal.

The configured beam information may include at least one of a configured beam index (or identifier), configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and reference signal identifier.

In the present disclosure, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, MAC message, and PHY message, and may identify a base station with which the terminal performs a beam monitoring operation, radio access operation, and/or control (or data) packet transmission and reception operation.

The result of the measurement operation (e.g., beam monitoring operation) for the beam may be reported through a physical layer control channel (e.g., PUCCH) and/or a MAC message (e.g., MAC CE, control PDU). Here, the result of the beam monitoring operation may be a measurement result for one or more beams (or beam groups). For example, the result of the beam monitoring operation may be a measurement result for beams (or beam groups) according to a beam sweeping operation of the base station.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam, a change from the deactivated beam to the active beam, a change from the primary beam to the secondary beam, a change from the secondary beam to the primary beam, a change from the primary beam to the reserved (or candidate) beam, or a change from the reserved (or candidate) beam to the primary beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more among scheduling information (e.g., radio resource allocation information, modulation and coding scheme (MCS) information), feedback information (e.g., channel quality indication (CQI), preceding matrix indicator (PMI), HARQ ACK, HARQ NACK), resource request information (e.g., scheduling request (SR)), result of the beam monitoring operation for supporting beamforming functions, TCI state ID, and measurement information for the active beam (or deactivated beam).

The physical layer control channel may be configured to be transmitted through the primary beam of downlink. In this case, the feedback information may be transmitted and received through the primary beam, and data scheduled by the control information may be transmitted and received through the secondary beam. The physical layer control channel may be configured to be transmitted through the primary beam of uplink. In this case, the resource request information (e.g., SR) and/or the feedback information may be transmitted and received through the primary beam.

In the procedure of allocating the plurality of beams (or the procedure of configuring the TCI states), the allocated (or configured) beam indexes, information indicating a spacing between the beams, and/or information indicating whether contiguous beams are allocated may be transmitted and received through a signaling procedure between the base station and the terminal. The signaling procedure of the beam allocation information may be performed differently according to status information (e.g., movement speed, movement direction, location information) of the terminal and/or the quality of the radio channel. The base station may obtain the status information of the terminal from the terminal. Alternatively, the base station may obtain the status information of the terminal through another method.

The radio resource information may include parameter(s) indicating frequency domain resources (e.g., center frequency, system bandwidth, PRB index, number of PRBs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The condition (e.g., reference value) indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to-noise ratio (SNR), a signal-to-interference ratio (SIR), or the like.

Meanwhile, in the NR communication system using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth. For example, BWPs may be configured as follows.

Measurement operations (e.g., monitoring operations) for beam (or TCI state) or radio link management may be performed at the base station and/or the terminal. The base station and/or the terminal may perform the measurement operations (e.g., monitoring operations) according to parameter(s) configured for the measurement operations (e.g., monitoring operations). The terminal may report a measurement result according to parameter(s) configured for measurement reporting.

When a reception quality of a reference signal according to the measurement result meets a preconfigured reference value and/or a preconfigured timer condition, the base station may determine whether to perform a beam (or, radio link) management operation, a beam switching operation, or a beam deactivation (or, activation) operation according to a beam blockage situation. When it is determined to perform a specific operation, the base station may transmit a message triggering execution of the specific operation to the terminal. For example, the base station may transmit a control message for instructing the terminal to execute the specific operation to the terminal. The control message may include configuration information of the specific operation.

When a reception quality of a reference signal according to the measurement result meets a preconfigured condition (e.g., reference value or threshold) and/or a preconfigured timer condition, the terminal may report the measurement result to the base station. Alternatively, the terminal may transmit to the base station a control message triggering a beam (or, radio link) management operation, a beam switching operation (or a TCI state ID change operation, a property change operation), or a beam deactivation operation (or a beam activation operation) according to a beam blockage situation. The control message may request to perform a specific operation.

A basic procedure for beam (or TCI state) management through the radio link monitoring may include a beam failure detection (BFD) procedure, a beam recovery (BR) request procedure, and the like for a radio link. An operation of determining whether to perform the beam failure detection procedure and/or the beam recovery request procedure, an operation triggering execution of the beam failure detection procedure and/or the beam recovery request procedure, and a control signaling operation for the beam failure detection procedure and/or the beam recovery request procedure may be performed by one or more of the PHY layer, the MAC layer, and the RRC layer.

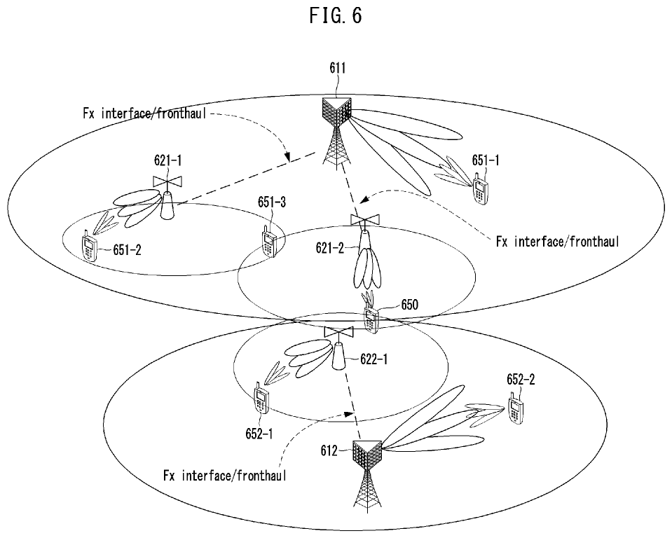

FIG. 6 is a conceptual diagram illustrating a first exemplary embodiment of a method of providing a service using a plurality of radio access points in a communication system.

Referring to FIG. 6, base stations 611 and 612 may provide services to radio access points 621-1, 621-2, and 622-1 within service coverages through wired interfaces or wireless interfaces. Interfaces between the base station 611 and the radio access points 621-1 and 621-2 within the service coverage of the base station 611 may be provided in a wired or wireless manner. An interface between the base station 612 and the radio access point 622-1 within the service coverage of the base station 612 may be provided in a wired or wireless manner. The function split scheme may be applied to the base stations 611 and 612. In this case, each of the base stations 611 and 612 may be configured as two or more nodes (e.g., CU and DU(s)) that perform radio protocol functions of each of the base stations 611 and 612.

The base stations 611 and 612 and the radio access points 621-1, 621-2, and 622-1 may each provide services to terminals 650, 651-1, 651-2, 651-3, 652-1, and 652-2 within each service coverage through wireless links (e.g., Uu interfaces). Transmission frequencies (or frequency bands) of the radio access points 621-1 and 621-2 within the base station 611 may be the same or different. When the radio access points 621-1 and 621-2 use the same frequency, the radio access points 621-1 and 621-2 may operate as the same cell having the same physical cell ID (PCI) or different cells having different PCIs.

When the radio access points 621-1 and 621-2 operate at the same frequency, the radio access points 621-1 and 621-2 provide a service to the terminal 651-3 in a single frequency network (SFN) scheme. The SFN scheme may refer to a scheme in which one or more radio access points simultaneously transmit the same data to the terminal using the same frequency. In order to provide the SFN scheme-based service, each of the radio access points 621-1 and 621-2 may transmit a downlink channel and/or signal to the terminal 653-1 by using the same resource (e.g., physical resource blocks (PRBs)) in the frequency and time domains. The terminal 653-1 may receive the downlink channel and/or signal from each of the radio access points 621-1 and 621-2 by using a beam (or radio resource) corresponding to a beam identifier (e.g., TCI state identifier) of each of the radio access points 621-1 and 621-2. Here, the expression ‘downlink channel and/or signal’ may refer to at least one of a downlink channel and a downlink signal. The TCI state identifier may refer to a TCI state ID or a TCI state index.

The radio access points 621-1 and 621-2 operating at the same frequency may not use the SFN scheme. In this case, each of the radio access points 621-1 and 621-2 may transmit a downlink channel and/or signal to the terminal 651-3 using a different resource (e.g., PRBs) in the frequency and time domains. The terminal 653-1 may receive the downlink channel and/or signal from each of the radio access points 621-1 and 621-2 by using abeam (or radio resource) corresponding to a beam identifier (e.g., TCI state identifier) of each of the radio access points 621-1 and 621-2.

The radio access points 621-1 and 621-2 may have different PCIs. In other words, the radio access points 621-1 and 621-2 may operate as different cells. The fact that the radio access points 621-1 and 621-2 operate as different cells may mean that the base station 611 includes two or more cells having different PCIs, and each of the radio access points 621-1 and 621-2 is a lower node (or radio access point) of a cell corresponding thereto. Alternatively, the fact that the radio access points 621-1 and 621-2 operate as different cells may mean that two or more cells having different PCIs exist within one DU included in the base station 611 to which the function split scheme is applied, and each of the radio access points 621-1 and 621-2 is a lower node (or radio access point) of a cell corresponding thereto.

When the radio access points 621-1 and 621-2 belong to different cells within a base station or a DU of the base station, a service for a terminal (e.g., terminal in the RRC connected state) that does not support carrier aggregation functions may be provided by one radio access point.

The base station may provide a service to a terminal using one or more cells or one or more radio access points. The base station to which the function split scheme is applied may include one CU and a plurality of DUs, and each of the plurality of DUs may provide a service to a terminal using one or more cells or one or more radio access points.

A control unit of the mobile communication network may partially restrict a transmission and/or reception operation of the above-described base station, cell, or radio access point (hereinafter referred to as ‘network node’) in the time domain, frequency domain, and/or spatial domain of a carrier, BWP, physical layer channel, or reference signal. Alternatively, the control unit of the mobile communication network may partially stop a transmission and/or reception operation of the network node in the time domain, frequency domain, and/or spatial domain of a carrier, BWP, physical layer channel, or reference signal. Alternatively, the control unit of the mobile communication network may adjust a transmission power of the network node. Through the above-described methods, the control unit of the mobile communication network may control a network energy saving (NES) function (or low power consumption) of the network node.

Here, the control unit of the mobile communication network may be an entity that performs a radio resource control (RRC) function of the base station. Alternatively, the control unit of the mobile communication network may be a central control node within the mobile communication network that performs a radio resource management (RRM) function and/or a self-organizing network (SON) function. The control unit of the mobile communication network may be deployed as being physically separated in form of functional blocks (or entities) according to their functions to be performed, and may be referred to as a ‘central control unit’ hereinafter.

The central control unit may be responsible for a traffic data transmission function in a data-plane provided through the mobile communication network, and a control parameter configuration and/or signaling operation for network nodes, which is required to support a mobility function and a connection control function in a control plane provided through the mobile communication network.

A first method for the NES (or low power consumption) function of the network node may be a method of performing an operation of stopping (or suspending) transmission (i.e., hereinafter, referred to as ‘transmission-off operation’) in the network node. Here, the transmission-off operation may refer to configuring the network node's physically present or configured transmitting end, or radio frequency (RF) transmitter (or RF chain), not to perform its function ultimately. The transmission-off operation may be performed on a base station, cell, radio access point, frequency (or transmission carrier), BWP, antenna, and/or transmission beam unit. Here, the transmission-off operation performed on an antenna basis may be performed according to the number of MIMO layers, the number of antenna ports, and/or the number of antennas.

The network node may transmit control information for configuring parameters for the transmission-off operation to terminal(s) within a service coverage using system information and/or a dedicated control message. The control information for the transmission-off operation may include at least one of a frequency (or carrier) of the network node to which the transmission-off operation is applied, identifier information of the network node (e.g., base station, cell, radio access point, BWP, antenna, and/or transmission beam) to which the transmission-off operation is applied, information on a time at which the transmission-off operation is applied, information on a start time of the transmission-off operation, uplink radio resource allocation information for performing a feedback information transmission and/or access procedure, or information on a (re)start time of transmission of the network node.

The transmission-off operation may be performed in consideration of state(s) of terminal(s) (refer to description of FIG. 3) within the service coverage of the network node, a quality of service(s) provided to the terminal(s), and/or the like. The transmission-off operation may be triggered when one or more of the following conditions are satisfied. Alternatively, when one or more of the following conditions are satisfied, the transmission-off operation may be performed.
\textcircled{1} Case when the number of terminals in the connected state within the service coverage meets a preset criteria
\textcircled{2} Case when the service quality for the terminal(s) in the connected state within the service coverage meets a preset criteria
\textcircled{3} Case when it is notified to the terminal(s) within the service coverage that transmission is stopped and/or transmission is scheduled to be stopped
\textcircled{4} Case when there isn't reception of feedback information from a terminal and/or access attempt from a terminal until a preset timer expires after the terminal(s) within the service coverage are notified that transmission is stopped and/or transmission is scheduled to be stopped
\textcircled{5} Case when a control message indicating the transmission-off operation is received from the central control unit

According to the condition \textcircled{1}, the transmission-off operation may be triggered or performed when the number of terminals receiving a service in the connected state (e.g., 301 in FIG. 3) and/or the number of terminals in the inactive state (e.g., 302 in FIG. 3) satisfies a preset condition N (e.g., N is an integer greater than or equal to ‘0’ or ‘1’). Here, satisfying the preset condition may refer to a case where the number of terminals is equal to or smaller than the set value N. In addition, the number of terminals may be counted by considering only the terminals in the connected state or by including terminals in the inactive state (in other words, when including terminals in the inactive state, the number of terminals may be calculated by summing the number of terminals in the connected state and the number of terminals in the inactive state). However, a terminal in the inactive state may mean only a terminal instructed to transition to the inactive state by the corresponding network node.

For example, the condition to be satisfied may be configured as a case when the number of terminals is equal to the value of N, and in this case, the value of N may be set to ‘2’. In this case, the network node may instruct the terminal(s) in the connected state among two terminals to handover to another cell. Alternatively, the network node may perform a related control procedure so that the terminal(s) in the connected and/or inactive state among the two terminals can receive a service from another network node. Thereafter, the network node may trigger or perform the transmission-off operation.

In addition, the condition to be satisfied may be configured as a case when the number of terminals is less than the value of N, and in this case, the value of N may be set to ‘1’. In this case, the network node may trigger or perform the transmission-off operation at a time when the number of terminals in the connected state and/or inactive state is identified as ‘0’ (i.e., when there is no terminal in the connected state and/or inactive state), or after expiration of a preset timer (e.g., transmission-off condition timer) from the time when the number of terminals in the connected state and/or inactive state is identified as ‘0’.

According to the condition \textcircled{2}, the network node may trigger or perform the transmission-off operation when a quality of a service provided to terminal(s) in the connected state does not satisfy a preset reference condition. Here, the quality of service may be configured or determined using one or more parameters among a radio channel quality measured and reported by the terminal(s), a quality of a radio channel for an uplink reference signal transmitted by the terminal and measured by the network node, a frequency (or number) of hybrid automatic repeat and request (HARQ) retransmissions of the service being provided, a frequency (or number of) radio link control (RLC) retransmissions, the number of radio link failure (RLFs) in a radio channel, the number of beam failure detections (BFDs), the number of beam failure recoveries (BFRs), the number of random access failures, and/or the number of physical layer out-of-synchronizations. Here, the quality of the radio channel may mean a signal quality of a physical layer channel in a radio section, which is measured as a channel state indicator (CSI), received signal strength indicator (RSSI), reference signal received power (RSRP), reference signal received quality (RSRQ), or signal to interference and noise ratio (SINR).

In other words, when a condition is configured as a combination of one or more of the aforementioned service quality parameters, the corresponding parameter(s) reported from the terminal and/or the service quality parameters measured or calculated by the network node may satisfy the condition. In this case, the network node may trigger or perform the transmission-off operation.

In addition, when a transmission-off condition timer indicating an actual start of the transmission-off operation after satisfying the condition is set, the network node may control the transmission-off operation to be performed when the corresponding timer, which is started at a time of satisfying the condition, expires. In addition, if a case in which the condition is not satisfied occurs before the transmission-off condition timer expires after being started, the transmission-off condition timer may be stopped or restarted. When the transmission-off condition timer is stopped, the network node may restart the operation (or procedure) of determining whether the condition is satisfied.

According to the condition \textcircled{3}, the transmission-off operation may be triggered or performed when control information or an indicator informing that the transmission-off operation is performed or the transmission-off operation is scheduled to be performed is transmitted from the network node to the terminal(s) in the connected state or idle state (e.g., 303 of FIG. 3). In the condition \textcircled{3}, the control information and/or indicator informing that transmission is stopped or and/or transmission is scheduled to be stopped may be transmitted through a physical downlink control channel (PDCCH) and/or a physical downlink shared channel (PDSCH) using a group scheduling identifier. Here, the control information and/or indicator informing that transmission is stopped or and/or transmission is scheduled to be stopped may include at least one among a frequency (or carrier) of the network node to which the transmission-off operation is applied, information on an identifier of the network node (e.g., base station, cell, radio access point, BWP, antenna, and/or transmission beam) to which the transmission-off operation is applied, information on a time at which the transmission-off operation is applied, information on a start time of the transmission-off operation, uplink radio resource allocation information for performing a feedback information transmission and/or access procedure, or information on a (re)start time of transmission of the network node.

In addition, the group scheduling identifier may be a group scheduling identifier for transmitting the control information informing that transmission is stopped or and/or transmission is scheduled to be stopped, and one or more of scheduling identifiers (e.g., cell radio network temporary identifier (C-RNTI)) may be designated or assigned as the group scheduling identifier. Accordingly, one or more terminal(s) within the service coverage of the network node may obtain (or receive) the control information and/or indicator informing that transmission is stopped or and/or transmission is scheduled to be stopped by monitoring the corresponding group scheduling identifier.

In addition, the control information informing that transmission is stopped or and/or transmission is scheduled to be stopped, which is transmitted through a PDCCH and/or PDSCH, may be transmitted using a paging message transmission procedure using a paging scheduling identifier (e.g., paging (P)-RNTI)), or a system information transfer and/or change notification procedure using a scheduling identifier (e.g., system information RNTI (SI-RNTI)) for system information transfer. In this case, identification information for distinguishing between the control information informing that transmission is stopped or and/or transmission is scheduled to be stopped and the existing paging message, system information transfer control message, and/or system information change notification control message may be included (or reflected). The identification information may be configured in form of an indicator, bearer identifier, logical channel identifier (LCID), header field parameter, DCI field parameter, and/or scrambling index.

When transmitted only through a PDCCH, the indicator and/or control information may be delivered to the terminal in form of a field parameter constituting DCI. In addition, when transmitted through a PDSCH, the indicator and/or control information may be delivered to the terminal in form of a MAC CE or RRC control message. Here, the MAC CE may mean a MAC layer control message configured in form of a MAC subheader, MAC header, logical channel identifier (LCID), MAC protocol data unit (PDU), and/or MAC subPDU.

According to the condition \textcircled{4}, when the terminal receives information informing that transmission is stopped or and/or transmission is scheduled to be stopped, if there isn't reception of feedback information and/or access attempt from a terminal within the service coverage until expiration of a preset timer (e.g., transmission-off initiation timer) from a time when the terminal recognizes the scheduled transmission-off operation or initiation of the transmission-off operation of the network node, the transmission-off operation may be triggered or performed.

The terminal may recognize the scheduled transmission-off operation or initiation of the transmission-off operation of the network node by receiving system information from the network node or receiving the control information and/or indicator informing that transmission is stopped or and/or transmission is scheduled to be stopped according to the condition \textcircled{3}.

In order to notify the scheduled transmission-off operation or initiation of the transmission-off operation of the network node using system information, the network node may transmit, through a master information block (MIB), system information block 1 (SIB1), and/or another SIB, one or more among an indicator indicating whether the network node supports (or performs) the transmission-off operation, information indicating a time at which the transmission-off operation starts, information on a time (or timer information) at which the transmission-off is applied, information indicating a (re)start time of transmission, or uplink radio resource allocation information for the terminal to perform a feedback information transmission and/or access procedure under the condition \textcircled{4}.

In addition, when the terminal receives (or acquires) the control information and/or indicator informing that transmission is stopped or and/or transmission is scheduled to be stopped according to the condition \textcircled{3}, the terminal may recognize the scheduled transmission-off operation or initiation of the transmission-off operation of the network node. In this case, in the condition \textcircled{4}, the network node may transmit scheduling information for an uplink radio resource allocated for performing a feedback information transmission and/or access procedure to the terminal by including it in the control information informing that transmission is stopped or and/or transmission is scheduled to be stopped, which is described in the condition \textcircled{3}.

According to the condition \textcircled{5}, the transmission-off operation of the network node may be triggered or performed when a control message indicating to stop transmission is received from the central control unit. In this case, the network node may start an operation (or procedure) of stopping transmission of the network node from a time when the control message is received. Alternatively, the network node may start a preset transmission-off condition timer at the time of receiving the control message, and start an operation (or procedure) of stopping transmission of the network node when the timer expires. Alternatively, the network node may start the transmission-off operation (or procedure) through one or a combination of the conditions \textcircled{1}, \textcircled{2}, \textcircled{3}, or \textcircled{4} described above.

Meanwhile, the network node may transmit, to the terminal(s), control information and/or an indicator notifying that transmission is stopped and/or transmission is scheduled to be stopped according to the above-described transmission-off operation method(s). The terminal may receive the control information and/or indicator notifying that transmission is stopped and/or transmission is scheduled to be stopped from the network node. In addition, according to the received control information and/or indicator notifying that transmission is stopped and/or transmission is scheduled to be stopped, the terminal may perform a random access (RA) procedure to the network node or transmit a control message and/or data packet for service provision by using an uplink control channel indicated by the uplink radio resource allocation information received from the network node through the configuration information for the transmission-off operation.

In other word, the transmission-off operation of the network node may be released when the uplink channel allocated for RA procedure is received from the terminal during the transmission-off operation or when an RA preamble, RA message, reference signal, L1/L2 control information, control message, and/or data packet is received from the terminal during the transmission-off operation. Accordingly, the network node may re(start) transmission operations. In other words, the network node performing the transmission-off operation may continuously monitor and/or receive a random access channel (e.g., RA preamble, RA message) configured in the network node for access of the terminal.

As described above, the network node may release the transmission-off operation by an uplink transmission of the terminal. In this case, the network node may transmit transmission-off operation release information (or information indicating a (re)start of transmission) to the terminal in the same manner as the transmission of the NES control message notifying the execution of the transmission-off operation.

Meanwhile, a second method for the NES (or low power consumption) function of the network nodes may be a method in which the network nodes periodically perform discontinuous transmission (DTX) operations and/or discontinuous reception (DRX) operations. Here, according to the DRX operation, the network node may perform monitoring of a radio channel in an on-duration or DRX active time according to a preset DRX cycle (or DRX periodicity) in order to save network energy, and may not perform monitoring of the radio channel in a sleep period or discontinuous reception period (i.e., opportunity for DRX) within the DRX cycle. The DRX active time may refer to a time during which the network node continuously performs a transmission/reception operation following an on-duration period when the transmission/reception operation of the network node is not completed in the on-duration period.

The base station may generate DRX configuration information for the DRX operation, and may transmit the generated DRX configuration information to the terminal. Then, the terminal may receive the DRX configuration information from the base station.

In addition, according to the DTX operation, similarly to the above-described DRX operation, the network node may transmit a radio channel in an on-duration or DTX active time according to a preset DTX cycle (or DTX periodicity), and may not perform transmission and/or reception of a radio channel in a sleep period or discontinuous transmission/reception period (i.e., opportunity for DTX or opportunity for DRX) within the DRX cycle.

The DTX active time may refer to a time during which the network node continuously performs a transmission/reception operation following an on-duration period when the transmission/reception operation of the network node is not completed in the on-duration period.

The base station may generate DTX configuration information for the DTX operation, and may transmit the generated DTX configuration information to the terminal. Then, the terminal may receive the DTX configuration information from the base station.

According to configuration of the central control unit, the DRX operation and DTX operation of the network node may be performed simultaneously according to the same cycle (or periodicity) or may be perform independently at different times (e.g., a case where cycles of the DRX operation and the DTX operation are different or a case where start times of the DRX operation and the DTX operation are different even when cycles thereof are the same). In addition, the network node may selectively configure or perform only one operation among the DTX operation and the DRX operation. Here, the DTX operation and the DRX operation may be characterized in that they are configured separately. Here, the DTX operation and the DRX operation may be configured separately. Here, the DTX operation and the DRX operation may be configured independently of each other.

The base station may transmit information indicating activation of at least one of the DTX operation and the DRX operation to the terminal. Then, the terminal may receive the information indicating activation of at least one of the DTX operation and the DRX operation from the base station.

In this case, the base station may transmit information indicating activation of at least one operation to the terminal by including it in a MAC CE or DCI. Accordingly, the terminal may receive the information indicating activation of at least one function, which is included in the MAC CE or DCI, from the base station. The MAC CE or DCI may further include information on a start time of the DTX operation or information on a start time of the DRX operation. The start time of each of the DTX operation and the DRX operation may be set in units of frames, slots, mini-slots, or symbols.

Alternatively, the base station may transmit information indicating deactivation of at least one function among an activated DTX operation and an activated DRX operation to the terminal. Accordingly, the terminal may receive the information indicating deactivation of at least one function from the base station. The information indicating deactivation of at least one function may be included in a MAC CE or DCI transmitted from the base station to the terminal.

Hereinafter, the DRX operation and/or the DTX operation may not be separately distinguished and may be collectively referred to as ‘DTX operation’. In the DTX operation (or NES operation) to be described below, the DTX operation and DRX operation of the network node may be performed together as described above or performed independently of each other. Alternatively, only one operation may be selectively performed. In particular, when the network node is operated as being divided into a transmission-only node and a reception-only node, only the DTX operation is configured and performed in the transmission-only node, and only the DRX operation is configured and performed in the reception-only node.

The DTX operation (or NES operation) of the network node for network energy saving of the mobile communication network may refer to an operation in which a physically present or configured transmitting end or RF transmitter (or RF chain) of the network node operates according to the DTX (or NES operation) cycle (or periodicity). The DTX cycle (or NES operation cycle) of the network node may be set smaller than the minimum UE DRX cycle configured for a DRX operation of the terminal. The DTX operation (or NES operation) may be performed on a base station, cell, radio access point, frequency (or transmission carrier), BWP, antenna, and/or transmission beam unit. Here, the DTX operation (or NES operation) performed on an antenna basis may mean that a discontinuous transmission operation may be performed according to the number of MIMO layers, the number of antenna ports, and/or the number of antennas.

Configuration information or parameters for supporting the DTX operation (or NES operation) function of the network node may be transmitted to the terminal using system information and/or a dedicated control message.

In order to notify the configuration information (i.e., DTX operation configuration information) for the DTX operation (or NES operation) using system information, the network node may deliver to the terminal, in form of a MIB, SIB1, other SIB, and/or dedicated control message (e.g., RRC control message), one or more among an indicator informing whether the network node supports (or performs) the DTX operation (or NES operation), information on a DTX (or NES operation) cycle, configuration information on a DTX (or NES operation) on-duration, information indicating a start time of the DTX operation (or NES operation), information on a timer for performing the DTX operation (or NES operation), allocation information of an uplink channel configured for reception from the terminal during the DTX operation (or NES operation), information indicating a release time of the operation. Here, the information indicating the start time of the DTX operation (or NES operation) may indicate a frame, slot, mini-slot, and/or symbol at which the DTX operation (or NES operation) of the network node starts, or may be information on an offset indicating a corresponding time point.

In addition, in order to notify the configuration information (i.e., DRX operation configuration information) for the DRX operation (or NES operation) using system information, the network node may deliver to the terminal, in form of a MIB, SIB1, other SIB, and/or dedicated control message (e.g., RRC control message), one or more among an indicator informing whether the network node supports (or performs) the DRX operation (or NES operation), information on a DRX (or NES operation) cycle, configuration information on a DRX (or NES operation) on-duration, information indicating a start time of the DRX operation (or NES operation), information on a timer for performing the DRX operation (or NES operation), allocation information of an uplink channel configured for reception from the terminal during the DRX operation (or NES operation), information indicating a release time of the operation. Here, the information indicating the start time of the DRX operation (or NES operation) may indicate a frame, slot, mini-slot, and/or symbol at which the DRX operation (or NES operation) of the network node starts, or may be information on an offset indicating a corresponding time point. The DRX operation and the DTX operation may be configured separately.

In other words, the information on the start time of the DTX operation may be an offset between a reception time of information indicating activation of the DTX operation and the start time of the DTX operation. Also, the information on the start time of the DRX operation may be an offset between a reception time of information indicating activation of the DRX operation and the start time of the DRX operation.

The execution of the DTX operation (or NES operation) of the network node may be determined according to the above-described conditions \textcircled{1}, \textcircled{2}, \textcircled{3}, \textcircled{4}, or \textcircled{5} for the transmission-off operation. In other words, whether to perform he DTX operation may be determined according to the number of terminals within the service coverage, quality of service being provided, DTX operation execution notification, and/or DTX operation execution indication from the central control unit. When it is determined that the network node is to perform the DTX operation, the network node may transmit control information and/or an indicator notifying that the DTX operation is to be performed to the terminal(s) within the service coverage.

The control information and/or indicator notifying execution of the DTX operation may be transmitted through a PDCCH and/or PDSCH using a group scheduling identifier. Here, the control information notifying the execution of the DTX operation may include one or more among a frequency (or carrier) of the network node to which the DTX operation is applied and/or an identifier of the network node (e.g., base station, cell, radio access point, BWP, antenna, and/or transmission beam), DTX cycle, configuration information of an on-duration of the DTX operation, information indicating a start time of the DTX operation, information on a timer for performing the DTX operation, allocation information of an uplink channel configured for reception from the terminal during the DTX operation, or information indicating a release time of the DTX operation of the network node. In addition, the group scheduling identifier may be a group scheduling identifier for transmitting the control information informing execution of the DTX operation, and one or more of scheduling identifiers (e.g., C-RNTI) may be designated or assigned as the group scheduling identifier. Accordingly, one or more terminal(s) within the service coverage of the network node may obtain (or receive) the control information and/or indicator informing the execution of the DTX operation by monitoring the corresponding group scheduling identifier.

In addition, the control information informing execution of the DTX operation, which is transmitted through a PDCCH and/or PDSCH, may be transmitted using a paging message transmission procedure using a paging scheduling identifier (e.g., P-RNTI), or a system information transfer and/or change notification procedure using a scheduling identifier (e.g., SI-RNTI) for system information transfer. In this case, identification information for distinguishing between the control information informing execution of the DTX operation and the existing paging message, system information transfer control message, and/or system information change notification control message may be included (or reflected) in the control information. The identification information may be configured in form of an indicator, bearer identifier, LCID, header field parameter, DCI field parameter, and/or scrambling index. When the control information informing DTX operation execution is transmitted through a PDCCH and/or PDSCH without using the group scheduling identifier, a terminal group may be indicated using field parameter information constituting the PDCCH (or DCI).

When the indicator (or control information) informing DTX operation execution is transmitted only through a PDCCH, the indicator and/or control information may be delivered to the terminal in form of a field parameter constituting DCI. In addition, when it is transmitted through a PDSCH, the indicator and/or control information may be delivered to the terminal in form of a MAC CE or RRC control message. Here, the MAC CE may mean a MAC layer control message configured in form of a MAC subheader, MAC header, LCID, MAC PDU, and/or MAC subPDU.

The network node may start performing a periodic DTX operation according to the DTX cycle at the start time according to the information on the start time of the DTX operation in the control information delivered to the terminal. In this case, the DTX operation of the network node may start when a transmission operation to the terminal and/or a reception operation from the terminal does not occur before a preset timer (e.g., DTX inactivity timer) expires until the start time of the DTX operation. The DTX operation may start from a DTX on-duration period or a discontinuous transmission period (opportunity for DTX) according to the DTX cycle.

When the DTX operation of the network node starts, the network node may perform a transmission operation in a DTX on-duration period or a DTX active time extended from the on-duration period. During such the time period, the terminal may perform monitoring and/or reception of a radio channel transmitted by the network node. When the DTX active time ends, the network node may not perform a transmission operation during a discontinuous transmission period (opportunity for DTX) or an on-duration period within the DTX cycle. The terminal may not perform a monitoring operation and/or reception operation for a radio channel of the network node during the discontinuous transmission period (or until a start time of the next on-duration period).

The network node may transmit only minimum signals or system information such as a synchronization signal, MIB, SIB1, and/or reference signal commonly applied to all terminals within the service coverage in an on-duration period or DTX active time.

Here, the synchronization signal may mean a primary synchronization signal (PSS) or a secondary synchronization signal (SSS). The reference signal may mean at least a reference signal required for path loss measurement performed, measurement of a quality of a radio channel, selection of a network node, and/or beam selection by the terminal. The reference signal may be a channel state information RS (CSI-RS), phase tracking RS (PT-RS), positioning RS (P-RS), or remote interference management RS (RIM-RS). Such the reference signal may not be UE-specifically allocated to a UE of the network node, and may be configured (or allocated) so that all terminals within the service coverage can receive it.

The synchronization signal, MIB, SIB1, or reference signal may be transmitted in one on-duration period or distributed and/or repeatedly transmitted over a plurality of on-duration periods located within a preconfigured transmission period.

When an RA preamble, RA message, reference signal, L 1/L2 control information, control message, and/or data packet is received from the terminal through an uplink channel allocated for RA procedure in an on-duration period or an uplink channel configured for reception from the terminal during the DTX operation, the network node may release the DTX operation. Accordingly, the network node performing the DTX operation may continuously perform a monitoring and/or reception operation for an RA channel (e.g., RA preamble, RA message) configured for the network node for access of the terminal.

Alternatively, the network node may perform a monitoring and/or reception operation for the RA channel (e.g., RA preamble, RA message) configured for the network node for access of the terminal in an on-duration period for the DTX operation (or active time). As described above, when the DTX operation of the network node is released, the network node may transmit DTX release information to the terminal in the same manner as the transmission of the above-described control information and/or indicator notifying the execution of the DTX operation. The DTX release information of the network node may be transmitted in the next on-duration period of the DTX operation.

The DTX cycle and/or DTX on-duration for the above-described DTX operation may be set in consideration of the DRX cycle or DRX on-duration for the DRX operation of the terminal configured by the network node to the terminal(s) within its service coverage. In other words, the DTX operation parameters of the network node may be configured to be aligned with the legacy DRX operation of the terminal. Here, the network node may be a base station.

Based on the above-described indicator indicating whether the network node supports and/or performs the NES operation, the terminal may obtain information on whether the network node operates the NES operation. The indicator indicating whether the NES operation is supported and/or performed may be transmitted from the network node to the terminal using system information (e.g., MIB or SIB1) or a dedicated control message. The indicator may be information indicating that the network node is a booster node, information indicating that the above-described NES operation is applied, or information indicating that the network node is a network node to which the NES operation is applicable. Even when the network node restricts camping of legacy terminals on the network node using baring information transmitted through a MIB and/or SIB1, the terminal supporting the NES function using the indicator indicating whether the NES operation is supported and/or performed may select the corresponding network node in a cell (re)selection procedure, and perform camping on the corresponding network node.

The corresponding indicator may consist of one or more bits. When the indicator is composed of a plurality of bits, the indicator may express information on capability information of the terminal, type (or form) of the network node, whether or not the network node supports the NES operation, and/or the like. Here, the capability information of the terminal may indicate a service type of the terminal (e.g., IoT device, wearable device, vehicle-mounted device, general user terminal, etc.), transmit power class, number of antennas, number of RF chains, and/or frequency band to be used. In the present disclosure, the capability information of the terminal may refer to UE capability information defined in the 3GPP technical specifications.

Accordingly, the terminal may give the network node a low priority in the cell (re)selection procedure for the network node or limit measurement/measurement reporting operations for the network node. Here, the booster node may refer to a node installed for service coverage extension. Alternatively, when a service is provided to the terminal using a plurality of network nodes through multi-radio access point, CA, and/or dual connectivity (DC) functions, the booster node may be a node that performs a role of a secondary network node.

The booster node may exist in form of a downlink-only node or an uplink-only node. The downlink-only node may perform only a transmission operation of downlink channels to the terminal and may not perform a reception operation of uplink channels from the terminal. Also, the uplink-only node may perform only a reception operation of uplink channels from the terminal and may not perform a transmission operation of downlink channels. The uplink-only node may perform a transmission operation of downlink channels (e.g., MIB, PSS, and/or SSS) for acquiring/maintaining physical layer synchronization.

A process for the above-described NES operation of the network node may be specified (or configured). In other words, a process (or process identifier) for control parameters such as the above-described transmission-off operation and DTX operation may be configured. When the NES operation of the network node is configured on a process basis, a process (or process identifier) may be specified (or configured) for each unit of the NES operation of the network node (e.g., base station, cell, radio access point, BWP, frequency (or transmission carrier), antenna (e.g., the number of MIMO layers, number of antenna ports, and/or number of antennas), and/or transmission beam, etc.). In addition, one or more processes may be specified (or configured) for each of the above-described transmission-off operation and DTX operation for NES operation of the network node.

When the process for the NES operation is specified as described above, the control information and/or indicator for the NES operation described above may include a process identifier for distinguishing the process of the corresponding NES operation. Alternatively, the control information and/or indicator for the NES operation described above may include a process identifier mapped to or associated with the process of the corresponding NES operation.

Accordingly, when the process identifier for the NES operation is configured, the terminal may obtain or distinguish a control message for the NES operation using only the process identifier. Hereinafter, a ‘NES control message’ may refer to control information obtained by adding the process identifier for the NES operation to the above-described control information and/or indicator for the NES operation. In other words, only by receiving the process identifier from the network node, the terminal may identify control parameters configured for the corresponding process among processes such as a process of indicating to perform the NES operation, a process of stopping/releasing of the NES operation, and/or one or more stored NES operation processes.

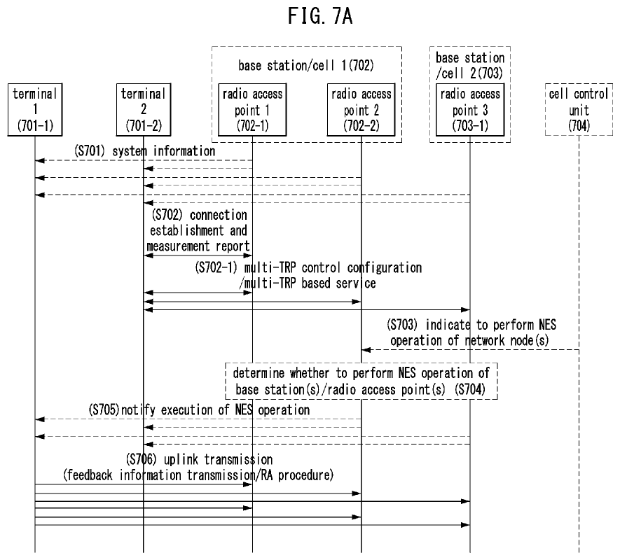

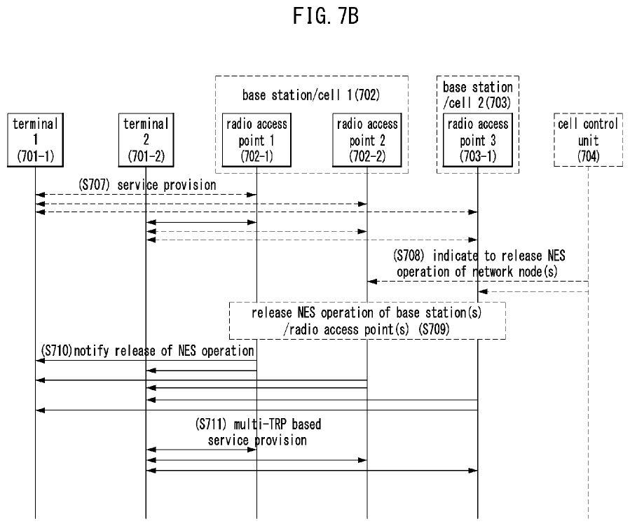

FIGS. 7A and 7B are sequence charts illustrating a first exemplary embodiment of a NES method in a communication system.

Referring to FIGS. 7A and 7B, a first radio access point 702-1 and a second radio access point 702-2 may be radio access points belonging to a first base station (or cell) 702. Also, a third radio access point 703-1 may be a radio access point belonging to a second base station (or cell) 703. In this case, the first radio access point 702-1 and the second radio access point 702-2 may be radio access points belonging to the same cell controlled by an RRC function of the first base station 702. Alternatively, the first radio access point 702-1 and the second radio access point 702-2 may be radio access points belonging to different cells controlled by the RRC function of the first base station 702.

A first terminal 701-1 and a second terminal 701-2 may be in the inactive state or idle state. In this case, the radio access points 702-1, 702-2, and 703-1 belonging to the base stations (or cells) 702 and 703 may transmit system information (S701). In addition, the radio access points 702-1, 702-2, and 703-1 belonging to the base stations (or cells) 702 and 703 may transmit reference signals.

In this case, the first terminal 701-1 and the second terminal 701-2 may receive the system information from the radio access points 702-1, 702-2, and 703-1 belonging to the base stations (or cells) 702 and 703. In addition, the first terminal 701-1 and the second terminal 701-2 may receive and measure the reference signals from the radio access points 702-1, 702-2, and 703-1 belonging to the base stations (or cells) 702 and 703. Accordingly, the first terminal 701-1 and the second terminal 701-2 may perform a cell selection/reselection procedure based on the system information and measurement results of the reference signals received from the radio access points 702-1, 702-2, and 703-1 belonging to base stations (or cells) 702 and 703, and select the first base station 702, which is an optimal cell, for camping. In this case, the system information may include control information for a NES operation of the network node. Accordingly, the first terminal 701-1 and the second terminal 701-2 in the inactive or idle state may obtain the control information for the NES operation of the network node described above from the system information.

Meanwhile, the second terminal 701-2 in the inactive state or idle state may perform an RA procedure with the first radio access point 702-1 belonging to the camped first base station 702 to establish an RRC connection with the first base station 702. The first radio access point 702-1 may provide a communication service to the second terminal 701-2 that has transitioned to the connected state. In this case, the second terminal 701-1 may measure a quality of the service according to the above-described condition \textcircled{2} for transmission-off operation, and report a measurement result to the first radio access point 702-1 (S702).

Through the signaling of the step S702 and/or an additional signaling after the step S702, the second terminal 701-2 may configure control parameters of multiple radio access points (e.g., TRPs) for function support using one or more radio access points 702-1, 702-2, and 703-1 and/or receive multiple radio access point (TRP)-based services (S702-1).

Meanwhile, the central control unit 704 may instruct the second radio access point 702-2 and the third radio access point 703-1, which are providing services to the second terminal 701, to perform the above-described NES operation of the network node (S703). Accordingly, the second radio access point 702-2 and the third radio access point 703-1 may receive the instruction to perform the NES operation by the network node from the central control unit 704. In addition, the second radio access point 702-2 and the third radio access point 703-1 may perform the NES operation according to received instruction of the network node.

On the other hand, separately from the instruction of the central control unit of the step S703 or based on condition parameters preconfigured by the central control unit, the base stations (or cells) 702 and 703 and/or the radio access points 702-1, 702-2, and 702-3 may determine whether entities and/or radio protocol layers in the radio access points 702-1, 702-2, and 702-3, which are responsible for the NES operation, perform the NES operation (S704). Then, the base stations (or cells) 702 and 703 and/or the radio access points 702-1, 702-2 and 703-1 may determine whether the entities and/or radio protocol layers in the radio access points 702-1, 702-2, and 702-3, which are responsible for the NES operation, perform the NES operation, based on the result of the foregoing determination, and may perform indication accordingly.

In this case, when the process for NES operation is configured, in the step S704, the base stations (or cells) 702 and 703 and/or the radio access points 702-1, 702-2 and 703-1 may determine and indicate whether to perform the NES operation for each process.

However, the first base station 702 may be a primary cell (PCell) for the second terminal 701-2. The second base station 703 may be a secondary cell (SCell) for the second terminal 701-2. Accordingly, the first base station 702 and the second base station 703 may support a CA function. In this case, a primary radio access point (e.g., the first radio access point 702-1) among radio access points belonging to the primary cell, or a specific radio access point (e.g., the first radio access point 702-1) determined by the primary cell based on a measurement result from the terminal and/or the above-described service quality condition(s) among the radio access points belonging to the primary cell may not perform the NES operation.

In addition, when the base stations 702 and 703 determine whether the radio access points 702-1, 702-2, and/or 703-1 perform the NES operation, the base stations 702 and 703 may transmit control message(s) indicating whether the radio access points 702-1, 702-2, and/or 703-1 perform the NES operation to the radio access points 702-2 and 703-1 determined to perform the NES operation, or change (or configure) parameters related to the corresponding radio access points. Alternatively, each of the radio access points 702-1, 702-2, and 703-1 may determine whether to perform the NES operation according to the result of performing the steps S703 and/or S704 and/or preconfigured condition parameter(s), and notify the terminal(s) 701-1 and 701-2 within the service coverage to perform the NES operation (S705). The NES control message(s) notifying to perform the NES operation in the step S705 may include a process identifier of the NES operation. According to the above example, in the step S705, the second radio access point 702-2 and the third radio access point 703-1 may transmit control information for the NES operation, process identifier of the NES operation, and/or indicator to the terminals 701-1 and 701-2.

In addition, the NES control message transmitted to the terminals in the step S705 may be transmitted using an RRC control message, MAC CE of the MAC layer, and/or DCI field parameter of the physical layer. When the NES control message is transmitted using a MAC CE, a MAC header and a LCID for identifying the corresponding MAC CE may be configured additionally. The MAC CE delivering the NES control message for the NES operation may include information on an identifier of a cell, radio access point, BWP, frequency (or transmission carrier), antenna, and/or transmission beam in which the NES operation is to be performed, process identifier of the NES operation, uplink radio resource allocation information for performing feedback information transmission and/or access procedure, information on a time for the above-mentioned NES operation, related timer information, information on an operation periodicity (or operation cycle), and/or identification information for identifying a service to which the NES operation is applied.

On the other hand, the information on an identifier of a cell, radio access point, BWP, frequency (or transmission carrier), antenna, and/or transmission beam, which is included in the MAC CE, may indicate an identifier of a cell, radio access point, BWP, frequency (or transmission carrier), antenna, and/or transmission beam in which the NES operation is not to be performed. Accordingly, the terminals 701-1 and 701-2 may distinguish network node(s) (or radio access point of FIGS. 7A and 7B) that perform the NES operation and network node(s) that do not perform the NES operation, based on the MAC CE.

Through the signaling of the step S705 and/or an additional signaling prior to a procedure of a step S706 described below, the base stations 702 and 703, the second radio access point 702-2, and/or the third radio access point 703-1 may deliver, to the terminals 701-1 and 701-2, control information indicating release, deactivation, or suspension of a semi-persistent scheduling (SPS) allocation for downlink radio resources and/or a configured grant (CG) allocation for uplink radio resources. The control information indicating release, deactivation, or suspension of the radio resources allocated in the SPS and/or CG scheme may be delivered from the base stations 702 and 703, the second radio access point 702-2, and/or the third radio access point 703-1 to the terminal(s) 701-1 and 701-2 in form of the above-described RRC control message, MAC CE, or DCI field parameter.

The control information may include identification information indicating the radio resources allocated in the SPS and/or CG scheme to be released, deactivated, or suspended. The terminals 701-1 and 701-2 receiving the control message indicating release, deactivation, or suspension of the radio resources allocated in the SPS and/or CG scheme may deactivate or suspend a monitoring operation and/or reception operation for the downlink SPS radio resources, and a transmission operation for the uplink CG radio resources during a sleep period or discontinuous transmission/reception period within a DTX cycle of the network node, or release the configuration of the allocated SPS radio resources and CG radio resources.

In addition, through the signaling of the step S705 and/or an additional signaling prior to the step S705, the base stations 702 and 703 and/or the radio access points 702-1, 702-2, and 703-1 may deliver, to the terminals 701-1 and 701-2 within the service coverage, control information indicating to perform a DRX operation or a go-to-sleep (GTS) operation of the terminal, which is configured in form of an RRC message, MAC CE, and/or DCI field parameters. That is, when it is determined through the steps S703 and/or S704 that the radio access points perform the NES operation, the base stations 702 and 703 and/or the radio access points 702-1, 702-2 and 703-1 may deliver, to the terminals 701-1 and 701-2 within the service coverage, the control information indicating to perform a DRX operation or a GTS operation, before the radio access points perform the NES operation.

In this case, a periodicity, cycle, and/or timer parameter(s) for performing the DRX operation or GTS operation may be aligned with parameters related to the NES operation of the base stations and/or radio access points, or may be configured to have a certain relationship therewith. In this case, the terminals 701-1 and 701-2 may perform NES operations according to preconfigured parameters for the DRX operation and/or GTS operation without performing the step S706 described below.

When service provision from the second radio access point 702-2 and/or the third radio access point 703-1 is required, the second terminal in the connected state, which receives the control message for performing the NES operation in the step S705, may transmit the above-described feedback information in the NES operation through an uplink channel, or may perform an RA procedure before the above-described ‘transmission-off start timer’ or ‘DTX inactivity timer’ expires (S706).

After the step S705, the network node (e.g., base station/cell, radio access point) performing the NES operation may perform a monitoring or reception operation for uplink radio resources allocated through the above-described ‘uplink radio resource allocation information for feedback information transmission and/or access procedure’ or ‘allocation information of an uplink channel configured for reception from a terminal during DTX operation’ in the control information for DTX operation, and/or uplink radio resources allocated for random access. The network node (e.g., base station/cell, radio access point) performing the NES operation may perform a monitoring or reception operation for the uplink radio resources, and receive, from the terminal, an RA channel (e.g., RA preamble, RA message) for access of the terminal, or feedback information requesting to stop the NES operation.

In addition, after the step S705, the terminal 701-1 in the inactive state or idle state, and the terminal 701-2 in the connection state for which uplink radio resources are not scheduled may transmit feedback information or perform an RA procedure through the uplink radio resources allocated through the above-described ‘uplink radio resource allocation information for feedback information transmission and/or access procedure’ or ‘allocation information of an uplink channel configured for reception from a terminal during DTX operation’ in the control information for DTX operation, and/or uplink radio resources allocated for random access (S706).

In the step S706, the terminals 701-1 and 701-2 may transmit the process identifier of the NES operation to notify whether or not the NES operation of the corresponding process is preferred. For example, the process identifier transmitted by the terminal according to configuration of the system may perform a role of preference information or feedback information indicating the terminal's preference for whether the terminal prefers to perform the NES operation corresponding to the process or the terminal prefers to exclude the execution of the NES operation.

After the step S705, the radio access points 702-1, 702-2, and 703-1 receiving the feedback information for the NES operation or the RA message including the RA preamble for the RA procedure from the terminals 701-1 and 701-2 may not perform the NES operation for the corresponding radio access points as described above. Accordingly, the corresponding network nodes 702-1, 702-2, and 703-1 that do not perform the NES operation may not perform a step S707 to be described below and may perform a step S709 to be described below.

The second terminal 701-1 notified that the second radio access point 702-2 and/or the third radio access point 703-1, which may support multi-radio access point-based services, perform the NES operation may receive services from the first radio access point 702-1 to which the NES operation is not applied (S707). In addition, in the step S707, the second terminal 701-1 may receive limited services from the second radio access point 702-2 and/or the third radio access point 703-1 performing the NES operation.

Here, the second radio access point 702-2 and/or the third radio access point 703-1 performing the NES operation may perform the transmission-off operation and DTX operation on a base station, cell, radio access point, BWP, frequency (or transmission carrier), antenna, and/or transmission beam unit. Accordingly, the terminals 701-1 and 701-2 may perform limited monitoring on a base station, cell, radio access point, BWP, frequency (or transmission carrier), antenna, and/or transmission beam unit. In other words, as described above, the terminals 701-1 and 701-2 may perform a monitoring and/or reception operation for a radio channel during an on-duration period or active time during the DTX operation. Alternatively, the terminals 701-1 and 701-2 may perform a monitoring and/or reception operation for a radio channel by using a base station, cell, radio access point, BWP, frequency (or transmission carrier), antenna, and/or transmission beam to which the transmission-off operation is not applied.

In the step S707, operation conditions and/or related parameters configured for supporting the multi-radio access point function configured in the terminal may not be released. In the step S707, service provision (or exchange of control signaling and/or data packets) between the corresponding network node and the terminal using a discontinuous transmission period according to the DTX operation and/or radio resources or radio channels to which the transmission-off operation of the network node is applied may be stopped.

Therefore, according to the NES operation, the terminals 701-1 and 701-2 may not perform a monitoring, reception, transmission, and/or measurement operation in the discontinuous transmission period according to the DTX operation, and/or on radio resources or radio channels to which the transmission-off operation of the network node is applied. Here, the fact that the terminals 701-1 and 701-2 do not perform a monitoring, reception, transmission, and/or measurement operation on radio resources or radio channels to which the NES operation is applied may mean that the corresponding operations are not performed for the above-described each NES performing unit (e.g., base station, cell, radio access point, BWP, frequency (or transmission carrier), antenna, and/or transmission beam).

The central control unit 704 may indicate the network nodes 702-2 and 703-1 performing the NES operation to release the NES operation (S708). Entities and/or radio protocol layers in charge of the NES functions in the base stations (or cells) 702 and 703 and/or radio access points 702-1, 702-2 and 703-1 according to preconfigured parameters as described above may determine whether to release the NES operation of the corresponding network nodes (S709). Alternatively, the network node may determine whether to release the NES operation of the network node according to reception of an uplink channel from the terminal. Alternatively, when receiving the indication to release the NES operation from the central control unit 704 through the step S708, the base stations 702 and 703 and/or the radio access points 702-1, 702-2 and 703-1 may release the NES operation. When the process for the NES operation is configured, release of the NES operation in the step S709 may be performed for each process of the NES operation. The base stations 702 and 703 and/or the radio access points 702-1, 702-2 and 703-1 may selectively transmit a message notifying release of the NES operation according to the above-described method (S710). The message indicating the release of the NES operation transmitted by the base stations 702 and 703 and/or the radio access points 702-1, 702-2 and 703-1 in the step S710 may be transmitted in form of an RRC message, MAC CE, and/or DCI described in the step S705. Also, in the step S710, the base station(s) and/or radio access point(s) may transmit control information (or indicator) including only the process identifier of the NES operation to inform the terminal(s) of the release of the NES operation of the corresponding process.

After the step S709 and/or step S710, the second terminal 701-2 may receive a service using a corresponding function according to conditions and/or parameters configured to support the multi-radio access point function (S711). In addition, the first terminal 701-1 in the inactive or idle state, which receives the control message notifying release of the NES operation of the network node (e.g., base station, cell, or radio access point) in the step S710, may perform operations according to the state of the terminal while maintaining configuration of the parameters (e.g., radio resource allocation information based on SPS and/or CG, DRX parameters, system information, etc.) preconfigured or stored in the terminal for support of the DRX operation, small data transmission (SDT), and/or the like.

In case that the terminals 701-1 and 701-2 can recognize the release time of the NES operation based on the above-described configuration parameters for the NES operation, the signaling in the step S710 may be omitted. In other words, based on the above-described configuration parameters for the NES operation (e.g., a (re)start time of transmission of the network node, DTX cycle, DTX on-duration, DTX active time, and/or the like), the terminal may recognize a time at which the above-described DTX operation or transmission-off operation is stopped or released, and may perform the monitoring operation, reception operation, and/or transmission operation for radio channels (or radio resources) for which the monitoring operation, reception operation, and/or transmission operation has been restricted (or suspended) again without receiving the signaling of the step S710.

In the description of FIGS. 7A and 7B, the control message in the step S705 notifying the base stations and/or the radio access points that the NES operation of the second radio access point 702-2 and/or the third radio access point 703-1 is performed, or the control message in the step S710 notifying the release of the NES operation may be transmitted to the terminals 701-1 and 701-2 through the first radio access point 702-1 instead of the second radio access point 702-2 or the third radio access point 703-1. In addition, the uplink transmission (e.g., feedback information transmission and/or RA procedure, etc.) performed by the terminal in the step S706 may be performed through the first radio access point 702-1 instead of the second radio access point 702-2 or the third radio access point 703-1.

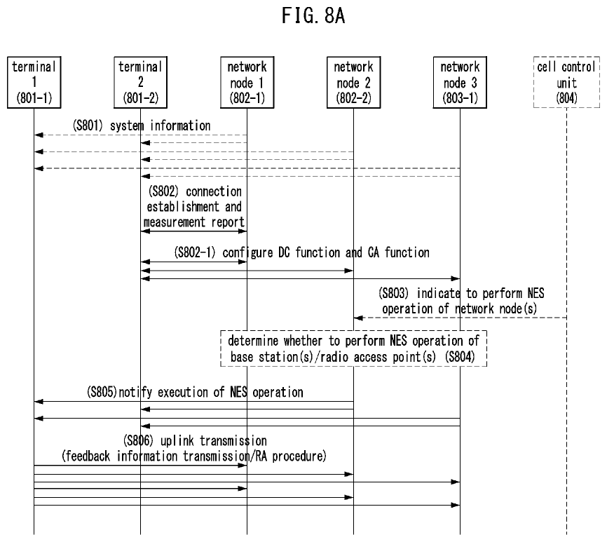

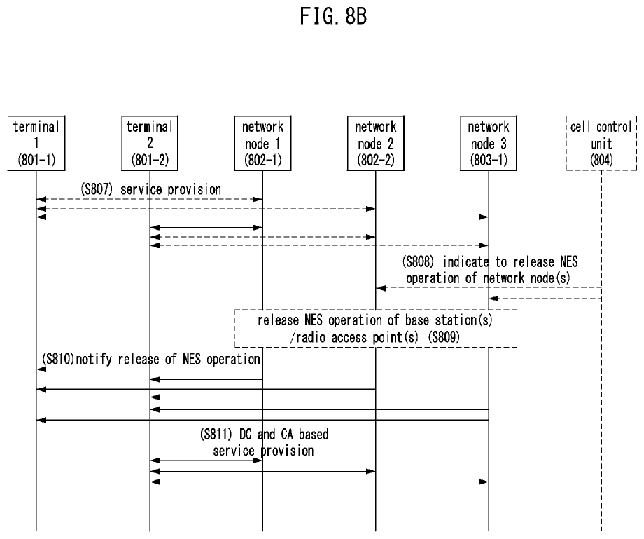

FIGS. 8A and 8B are sequence charts illustrating a second exemplary embodiment of a NES method in a communication system.

Referring to FIGS. 8A and 8B, a first radio access point 802-1 and a second radio access point 802-2 may be radio access points belonging to a first base station (or cell). Also, a third radio access point 803-1 may be a radio access point belonging to a second base station (or cell). In this case, the first radio access point 802-1 and the second radio access point 802-2 may be radio access points belonging to the same cell controlled by an RRC function of the first base station. Alternatively, the first radio access point 802-1 and the second radio access point 802-2 may be radio access points belonging to different cells controlled by the RRC function of the first base station.

A first terminal 801-1 and a second terminal 801-2 may be in the inactive state or idle state. In this case, the network nodes 802-1, 802-2, and 803-1 may transmit system information (S801). In addition, the network nodes 802-1, 802-2, and 803-1 may transmit reference signals.

In this case, the first terminal 801-1 and the second terminal 801-2 may receive the system information from the network nodes 802-1, 802-2, and 803-1. In addition, the first terminal 801-1 and the second terminal 801-2 may receive and measure the reference signals from the network nodes 802-1, 802-2, and 703-1. Accordingly, the first terminal 801-1 and the second terminal 801-2 may perform a cell selection/reselection procedure based on the system information and measurement results of the reference signals received from the network nodes 802-1, 802-2, and 803-1, select the first network node 802-1, which is an optimal cell, and perform camping on the first network node 802-1. In this case, the system information may include control information for a NES operation of the network node(s). Accordingly, the first terminal 801-1 and the second terminal 801-2 in the inactive or idle state may obtain the control information for the NES operation of the network node(s) described above from the system information.

Meanwhile, the second terminal 801-2 in the inactive state or idle state may perform an RA procedure with the first network node 802-1 on which the second terminal 801-2 is camped to establish an RRC connection with the first network node 802-1. The first network node 802-1 may provide a communication service to the second terminal 801-2 that has transitioned to the connected state. In this case, the second terminal 801-1 may measure a quality of the service according to the above-described condition \textcircled{2} for transmission-off operation, and report a measurement result to the first network node 802-1 (S802).

Through the signaling of the step S802 and/or an additional signaling after the step S802, the second terminal 801-2 may configure support of a DC function and a CA function for supporting the DC function and CA function using the one or more network nodes 802-1, 802-2, and 803-1 (S802-1).

In other words, through the signaling of the step S802 and/or additional signaling after the step S802, the second network node 802-2 may be configured as an SCell to support the CA function, or the third network node 803-1 may be configured as a secondary node to support the DC function. Therefore, when the CA and/or DC function is configured in the second terminal 801-2, a node (e.g., the first network node 802-1) having an RRC layer controlling the first network node and the second network node may serve as a master node for the DC function, and/or may also serve as a primary cell (PCell) for the CA function.

The NES operation may be excluded or application of the NES operation may be restricted for the primary cell (PCell) for supporting the CA function, the primary cell (PCell) of the master node (or primary cell group) and a primary cell (PSCell) of the secondary node (or secondary cell group) for supporting the DC function, or a special cell. Here, the special cell may refer to a cell in which a contention-based RA procedure and a physical layer uplink control channel (PUCCH) is configured. In other words, the transmission-off operation and/or the DTX operation of the network node may not be performed in the corresponding cell (PCell, PSCell, or special cell), or an execution unit of the transmission-off operation and DTX operation in the corresponding cell may be limited to a radio access point, BWP, frequency (or transmission carrier), antenna, and/or transmission beam.

On the other hand, the central control unit 804 may indicate the second network node 802-2 and the third network node 803-1, which are providing services to the second terminal 801, to perform the above-described NES operation of the network nodes (S803). Accordingly, the second network node 802-2 and the third network node 803-1 may receive the indication to perform the NES operation from the central control unit 804. Then, the second network node 802-2 and the third network node 803-1 may perform the NES operation according to the received indication to perform the NES operation.

Meanwhile, separately from the indication of the central control unit in the step S803 or based on condition parameters previously configured by the central control unit, entities and/or radio protocol layers in charge of the NES function of the network nodes 802-1, 802-2, and 803-1 may determine whether to perform the NES operation (S804). In addition, based on a result of the determination, the entities and/or radio protocol layers in charge of the NES function of the network nodes 802-1, 802-2, and 803-1 may determine and indicate whether to perform the NES operation.

In this case, when a process for the NES operation is configured, the determination and indication of whether to perform the NES operation in the step S804 may be performed by the network nodes 802-1, 802-2, and 803-1 determining whether to perform the NES operation for each process.

However, the first network node and the second network nodes 802-1 and 802-3 may be primary cells (PCells) for the second terminal 801-2. The third network node 803-1 may be a secondary cell (SCell) for the second terminal 801-2. Accordingly, the first to third network nodes 802-1, 802-2, and 803-1 may support a CA function. In this case, a primary radio access point (e.g., the first network node 802-1) among radio access points belonging to the primary cell, or a specific network node (e.g., the first network node 802-1) determined by the primary cell based on measurement results from the terminal(s) and/or the above-described service quality condition during the NES operation may not perform the NES operation.

In addition, when the base stations determine whether the network nodes 802-1, 802-2, and/or 803-1 perform the NES operation, the base stations may transmit control message(s) indicating the network nodes 802-1, 802-2, and/or 803-1 to perform the NES operation to the network nodes 802-2 and 803-1 determined to perform the NES operation, or change (or configure) parameters related to the corresponding network nodes. Alternatively, each of the network nodes 802-1, 802-2, and 803-1 may determine whether to perform the NES operation according to the result of performing the steps S803 and/or S804 and/or preconfigured condition parameter(s), and notify the execution of the NES operation to the terminal(s) 801-1 and 801-2 within the service coverage (S805). The NES control message(s) notifying the execution of the NES operation in the step S805 may include a process identifier of the NES operation. According to the above example, in the step S805, the second network node 802-2 and the third network node 803-1 may transmit control information for the NES operation, process identifier of the NES operation, and/or indicator information to the terminals 801-1 and 801-2.

In addition, the NES control message transmitted to the terminals in the step S805 may be transmitted using an RRC control message, MAC CE of the MAC layer, and/or DCI field parameter of the physical layer. When the NES control message is transmitted using a MAC CE, a MAC header and a LCID for identifying the corresponding MAC CE may be configured additionally. The MAC CE delivering the NES control message for the NES operation may include information on an identifier of a cell, radio access point, BWP, frequency (or transmission carrier), antenna, and/or transmission beam in which the NES operation is to be performed, process identifier of the NES operation, uplink radio resource allocation information for performing feedback information transmission and/or RA procedure, information on a time for the above-mentioned NES operation, related timer information, information on an operation periodicity (or operation cycle), and/or identification information for distinguishing a service to which the NES operation is applied.

On the other hand, the information on an identifier of a cell, radio access point, BWP, frequency (or transmission carrier), antenna, and/or transmission beam, which is included in the MAC CE, may indicate an identifier of a cell, radio access point, BWP, frequency (or transmission carrier), antenna, and/or transmission beam in which the NES operation is not to be performed. Accordingly, the terminals 801-1 and 801-2 may distinguish network node(s) that perform the NES operation and network node(s) that do not perform the NES operation, based on the MAC CE.

Through the signaling of the step S805 and/or an additional signaling prior to a procedure of step a S806 described below, the second network node 802-2 and/or the third network node 803-1 may deliver, to the terminals 801-1 and 801-2, control information indicating release, deactivation, or suspension of an SPS allocation for downlink radio resources and/or a CG allocation for uplink radio resources. The control information indicating release, deactivation, or suspension of the radio resources allocated in the SPS and/or CG scheme may be delivered from the second network node 802-2 and/or the third network node 803-1 to the terminal(s) 801-1 and 801-2 in form of the above-described RRC control message, MAC CE, or DCI field parameter. The control information may include identification information indicating the radio resources allocated in the SPS and/or CG scheme to be released, deactivated, or suspended. The terminals 801-1 and 801-2 receiving the control message indicating release, deactivation, or suspension of the radio resources allocated in the SPS and/or CG scheme may deactivate or suspend a monitoring operation and/or reception operation for the downlink SPS radio resources, and a transmission operation for the uplink CG radio resources, or release the configuration of the allocated SPS radio resources and CG radio resources.

In addition, through the signaling of the step S805 and/or an additional signaling prior to the step S805, the base stations and/or the network nodes 802-1, 802-2, and 803-1 may deliver, to the terminals 801-1 and 801-2 within the service coverage, control information indicating to perform a DRX operation or a GTS operation of the terminal, which is configured in form of an RRC message, MAC CE, and/or DCI field parameters. That is, when it is determined through the steps S803 and S804 that the network nodes perform the NES operation, the base stations and/or the network nodes 802-1, 802-2 and 803-1 may deliver, to the terminals 801-1 and 801-2 within the service coverage, the control information indicating to perform a DRX operation or a GTS operation, before the network nodes perform the NES operation. In this case, a periodicity, cycle, and/or timer parameter for performing the DRX operation or GTS operation may be aligned with parameters related to the NES operation of the base stations and/or radio access points, or may be configured to have a certain relationship therewith. In this case, the terminals 801-1 and 801-2 may perform NES operations according to preconfigured parameters for the DRX operation and/or GTS operation without performing the step S806 described below.

When service provision from the second network node 802-2 and/or the third network node 803-1 is required, the second terminal 801-2 in the connected state, which receives the control message notifying execution of the NES operation in the step S805, may transmit the above-described feedback information in the NES operation through an uplink channel, or may perform an RA procedure before the above-described ‘transmission-off start timer’ or ‘DTX inactivity timer’ expires (S806).

After the step S805, the network node (e.g., base station/cell, radio access point) performing the NES operation may perform a monitoring or reception operation for uplink radio resources allocated through the above-described ‘uplink radio resource allocation information for feedback information transmission and/or access procedure’ or ‘allocation information of an uplink channel configured for reception from a terminal during DTX operation’ in the control information for DTX operation, and/or uplink radio resources allocated for random access. The network node (e.g., base station/cell, radio access point) performing the NES operation may perform a monitoring or reception operation for the corresponding uplink radio resource, and receive, from the terminal, an RA channel (e.g., RA preamble, RA message) for access of the terminal, or feedback information requesting to stop the NES operation.

In addition, after the step S805, the terminal 801-1 in the inactive state or idle state, and the terminal 801-2 in the connection state for which uplink radio resources are not scheduled may transmit feedback information or perform an RA procedure through the uplink radio resources allocated through the above-described ‘uplink radio resource allocation information for feedback information transmission and/or access procedure’ or ‘allocation information of an uplink channel configured for reception from a terminal during DTX operation’ in the control information for DTX operation, and/or uplink radio resources allocated for random access (S806).

In the step S806, the terminals 801-1 and 801-2 may transmit the process identifier of the NES operation to notify whether or not the NES operation of the corresponding process is preferred. For example, the process identifier transmitted by the terminal according to configuration of the system may perform a role of preference information or feedback information indicating the terminal's preference for whether the terminal prefers to perform the NES operation corresponding to the corresponding process or the terminal prefers to exclude the execution of the NES operation.

After the step S805, the network nodes 802-1, 802-2, and 803-1 receiving the feedback information for the NES operation or an RA message or RA preamble for RA procedures from the terminals 801-1 and 801-2 may not perform the NES operation for the corresponding network nodes as described above. Accordingly, the corresponding network nodes 802-1, 802-2, and 803-1 that do not perform the NES operation may not perform a step S807 to be described below and may perform a step S809 to be described below.

The second terminal 801-1 notified that the second network node 802-2 and/or the third network node 803-1, which may support the DC function and/or CA function, perform the NES operation may receive services from the first network node 802-1 to which the NES operation is not applied (S807). In addition, in the step S807, the second terminal 801-1 may receive limited services from the second network node 802-2 and/or the third network node 803-1 performing the NES operation.

Here, the second network node 802-2 and/or the third network node 803-1 performing the NES operation may perform the transmission-off operation and DTX operation on a base station, cell, radio access point, BWP, frequency (or transmission carrier), antenna, and/or transmission beam unit. Accordingly, radio resources that can be monitored or transmitted/received by the terminals 801-1 and 801-2 may be restricted on a base station, cell, radio access point, BWP, frequency (or transmission carrier), antenna, and/or transmission beam unit. In other words, as described above, the terminals 801-1 and 801-2 may perform a monitoring and/or reception operation for a radio channel during an on-duration period or active time during the DTX operation. Alternatively, the terminals 801-1 and 801-2 may perform a monitoring and/or reception operation for a radio channel by using a base station, cell, radio access point, BWP, frequency (or transmission carrier), antenna, and/or transmission beam to which the transmission-off operation is not applied.

In the step S807, operation conditions and/or related parameters configured for supporting the multi-radio access point function configured in the terminal may not be released. In the step S807, service provision (or exchange of control signaling and/or data packets) between the corresponding network node and the terminal using the discontinuous transmission period according to the DTX operation and/or radio resources or radio channels to which the transmission-off operation of the network node is applied may be suspended. Therefore, according to the NES operation, the terminals 801-1 and 801-2 may not perform a monitoring, reception, transmission, and/or measurement operation in a discontinuous transmission period according to the DTX operation and/or on radio resources or radio channels to which the transmission-off operation of the network is applied. Here, the fact that the terminals 801-1 and 801-2 do not perform a monitoring operation, reception operation, transmission operation, and/or measurement operation on radio resources or radio channels to which the NES operation is applied may mean that the corresponding operations are not performed for each NES operation performing unit (e.g., base station, cell, radio access point, BWP, frequency (or transmission carrier), antenna, and/or transmission beam).

The central control unit 804 may indicate the network nodes 802-2 and 803-1 performing the NES operation to release the NES operation (S808). According to parameters preconfigured as described above, the base stations (or cells) and/or network nodes 802-1, 802-2 and 803-1 may determine whether to release the NES operation of the corresponding network nodes (S809). Alternatively, the network node may determine whether to release the NES operation of the network node according to reception of an uplink channel from the terminal. Alternatively, when receiving the indication to release the NES operation from the central control unit 804 through the step S808, the base stations and/or the network nodes 802-1, 802-2 and 803-1 may release the NES operation. When the process for the NES operation is configured, release of the NES operation in the step S809 may be performed for each process of the NES operation. The base stations and/or the network nodes 802-1, 802-2 and 803-1 may selectively transmit a message notifying release of the NES operation according to the above-described method (S810). The message indicating the release of the NES operation transmitted by the base stations and/or the network nodes 802-1, 802-2 and 803-1 in the step S810 may be transmitted in form of an RRC message, MAC CE, and/or DCI described in the step S805. Also, in the step S810, the base station and/or radio access point(s) may transmit control information (or indicator) including only the process identifier of the NES operation to inform the terminal(s) of the release of the NES operation of the corresponding process.

After the step S809 and/or step S810, the second terminal 801-2 may receive preconfigured DC and/or CA based service (S811). In addition, the first terminal 801-1 in the inactive or idle state, which receives the control message notifying release of the NES operation of the network node (e.g., base station, cell, or radio access point) in the step S810, may perform operations according to the state of the terminal while maintaining configuration of the parameters (e.g., radio resource allocation information based on SPS and/or CG, DRX parameters, system information, etc.) preconfigured or stored in the terminal for support of the DRX operation, SDT, and/or the like.

In case that the terminals 801-1 and 801-2 can recognize the release time of the NES operation based on the above-described configuration parameters for the NES operation, the signaling in the step S810 may be omitted. In other words, based on the above-described configuration parameters for the NES operation (e.g., a (re)start time of transmission of the network node, DTX cycle, DTX on-duration, DTX active time, and/or the like), the terminal may recognize a time at which the above-described DTX operation or transmission-off operation is stopped or released, and may perform the monitoring operation, reception operation, and/or transmission operation for radio channels (or radio resources) for which the monitoring, reception operation, and/or transmission operation has been restricted (or suspended) again without receiving the signaling of the step S810.

In the description of FIGS. 8A and 8B, the control message in the step S805 notifying the NES operation of the base stations and/or second network node 802-2 and/or third network node 803-1, or the control message in the step S810 notifying the release of the NES operation may be transmitted to the terminals 801-1 and 801-2 through the first network node 802-1 instead of the second network node 802-2 or the third network node 803-1. In addition, the uplink transmission (e.g., feedback information transmission and/or random access procedure, etc.) performed by the terminal in the step S806 may be performed through the first network node 802-1 instead of the second network node 802-2 or the third network node 803-1.

The network node performing the NES operation such as the transmission-off operation or DTX operation described above may discretely transmit only SSBs (e.g., synchronization signal and MIB) or discretely transmit only SSBs and SIB1 by using a minimum bandwidth or BWP (e.g., initial BWP or default BWP). Here, the discrete transmission of the SSBs may mean discontinuous transmission according to an SSB periodicity. In other words, the network node may repeat an operation of transmitting SSBs during 20 ms and an operation of not transmitting SSBs during 20 ms with a corresponding periodicity or cycle (e.g., periodicity of ms). Here, the periodicity of the SSB may mean an SSB generation periodicity, SSB transmission periodicity, or SSB reception periodicity.

The periodicity of the SSB may be delivered to the terminal using a field parameter in the MIB, system information, or a dedicated control message. In the case of using system information or a dedicated control message, the system information or dedicated control message may include system information on adjacent cell(s), system information including NES information of the network node, or NES information of the network node. The periodicity of the SSB may be implicitly signaled through a function or modulo operation of a cell identifier and/or a PSS and/or SSS within the SSB. Alternatively, the periodicity of the SSB may be implicitly signaled using SSB block type information within the MIB.

When implicitly signaled, the terminal may obtain information on the periodicity of the SSB using the SSB block type information, cell identifier, PSS, and/or SSS during SSB reception. For example, when the modulo operation is used and the number of configurable generation periodicities is at most 2, if a result value of the modulo operation using ‘2’ (e.g., when a modulo operation based on the cell identifier (e.g., (cell identifier mod 2)) is used) is ‘0’, the SSB generation periodicity may be set to 20 ms. On the other hand, if the result value is ‘1’, the terminal may set the SSB generation periodicity to 40 ms.

In addition, the network node performing the NES operation may stop the NES operation in order to transmit system information, paging message, emergency disaster message, and/or the like, and transmit the corresponding system information, paging message, emergency disaster message, and/or the like. For example, the network node performing the DTX operation may transmit the corresponding message during an on-duration period according to the DTX cycle or active time.

In order to restrict camping of the terminals through access and/or cell (re)selection procedures, the network node performing the above-described NES operation may transmit control information and/or indicator notifying baring and/or access (or camping) exclusion. Therefore, even when the network node restricts camping on the corresponding network node by using baring information transmitted through the MIB and/or SIB1, the terminal supporting the NES function may select the network node and camp on (or attempt to access) the network node in the cell (re)selection procedure by using the control information and/or indicator notifying baring and/or access (or camping) exclusion.

The corresponding indicator may consist of one or more bits. When the indicator is composed of a plurality of bits, the indicator may express information on capability information of the terminal, type (or form) of the network node, whether or not the network node supports the NES operation, and/or the like. Here, the capability information of the terminal may indicate a service type of the terminal (e.g., IoT device, wearable device, vehicle-mounted device, general user terminal, etc.), transmit power class, number of antennas, number of RF chains, and/or frequency band to be used.

In addition, the network node performing the NES operation may configure or transmit the control information and/or indicator notifying baring and/or access (or camping) exclusion for the network node in the access and/or cell (re)selection procedure of the terminal, for each cell or radio access point. For example, in FIGS. 7A and 7B, the control information or indicator notifying baring and/or access (or camping) exclusion may be transmitted only by the second radio access point 702-2 among the first radio access point 702-1 and the second radio access point 702-2 belonging to the same cell 702. In other words, the first radio access point 702-1 may not transmit the control information or indicator notifying baring and/or access (or camping) exclusion.

In addition, in order to determine whether or not to continue performing the NES operation based on whether terminal(s) exist within the service coverage and/or a request of terminal(s), the network node performing the NES operation may perform a monitoring and/or reception operation for an uplink RA channel of the corresponding network node and/or adjacent network node(s). For example, the network node performing the NES operation may obtain configuration information on an uplink RA channel of the adjacent network node(s) by exchanging a pre-control message with the adjacent network node(s). The network node performing the NES operation may recognize an access request of terminal(s) using an uplink channel by monitoring an uplink RA channel of adjacent network node(s) based on the configuration information on the uplink RA channel of adjacent network node(s) which is previously obtained. Alternatively, the network node performing the NES operation may measure a received power and/or radio channel quality (e.g., RSSI, RSRP, etc.) for the corresponding uplink channel, and determine whether or not to stop performing the NES operation for service provision to the terminal and/or support of camping through a cell (re)selection procedure.

In addition, the terminal in the inactive state or idle state may identify the network node performing the NES operation in the cell (re)selection procedure for camping, according to the method described above, and exclude the corresponding network node from targets of the cell (re)selection procedure or manage the corresponding network node with a low priority. For example, based on the indicator indicating whether the network node supports and/or performs the NES operation, the terminal may obtain information on whether the network node performs the NES operation.

In addition, a terminal in the inactive or idle state that has not found a network node that meets conditions for the cell (re)selection procedure for a camping cell may perform an RA procedure to the network node performing the NES operation, or may request the corresponding network node to stop performing the NES operation. In this case, the terminal may obtain configuration information on an uplink RA channel resource of the network node performing the NES operation from an adjacent network node. In other words, the network node performing the NES operation and the adjacent network node may exchange control messages therefor in advance. Accordingly, the adjacent network node may transmit the configuration information on an uplink RA channel resource of the network node performing the NES operation to the terminal by using system information and/or a dedicated control message of the adjacent network node. Therefore, the terminal in the inactive state or idle state may perform an RA procedure to the network node performing the NES operation or request the network node to stop performing the NES operation by using the configuration information on an uplink RA channel resource which is obtained from the adjacent network node.

For the above-described NES operation of the network node, the network node may perform a counting procedure for identifying a need to continue service provision of the network node for terminals within the service coverage. Here, the counting procedure for identifying the need to continue service provision may be to identify whether the terminals in the connected state continue to receive services through the network node despite a service level change due to the network node performing the NES operation. In addition, the counting procedure for identifying the need to continue service provision may be to identify whether the terminals in the inactive state or idle state maintain camping on the network node even when the network node performs the NES operation.

For the counting procedure described above, the network node may transmit a control message notifying a start of counting to terminals within the service coverage before performing the NES operation. Accordingly, the terminal receiving the control message may transmit response information and/or feedback information for the counting to the network node. The control message indicating the start of counting may be transmitted in form of DCI (PDCCH), MAC CE, or RRC control message. The terminal may transmit the response information and/or feedback information for the control message to the network node in form of an RA preamble, RA message, MAC CE, and/or RRC control message. The response information and/or feedback information for the counting may include preference information of the terminal on whether or not the service of the network node is maintained even when the network node performs the NES operation, whether camping on the network node is maintained even when the network node performs the NES operation, or whether the network node performs the NES operation. The network node may determine whether to perform the NES operation by referring to a result of the counting.

In addition, the network node may refer to the result of counting to determine or indicate whether or not to perform a handover or redirection of the terminal in the connected state to another network node of the same radio access technology (RAT) (i.e., intra-RAT case) or a different RAT (i.e., inter-RAT case). The NES operation of the network node described above may be applied only to a booster node performing a service coverage extension function or a secondary network node function. In other words, a primary cell (PCell) of CA function and/or a special cell (SpCell) of DC function may not perform the NES operation.

Here, the special cell may mean a primary cell in a master cell group (MCG) belonging to a master node for supporting the DC function and a primary secondary cell (PSCell) in a secondary cell group (SCG) belonging to a secondary node. The booster node may be a network node covering the entire coverage. Alternatively, the booster node may be a network node for extending the service coverage at a cell boundary. Alternatively, the booster node may be secondary cell(s) for supporting the CA/DC function support. Alternatively, the booster node may refer to a network node such as radio access point(s) belonging to the corresponding secondary cell(s). Only the booster node may be controlled to perform the NES operation. In this case, configuration parameters for the NES operation may be transmitted to the terminal using a control message for supporting the CA function and DC function or a control message for configuring the booster node for service coverage extension.

In particular, a booster node belonging to the same timing advance group (TAG) in a cell group supporting the CA or DC function (e.g., a cell that is neither a PCell of the CA function nor a special cell of the DC function, and/or network node such as a radio access point belonging to the corresponding cell) may perform the NES operation without SSB transmission or restrictions due to SSB transmission. For example, in the DTX operation of the network node, the booster node may set a DTX cycle without restrictions on the aforementioned 20 ms SSB periodicity. In other words, the booster node may not set the DTX cycle to a multiple of 20 ms or may set the DTX cycle to a cycle greater than 80 ms.

In addition, the performing of the NES operation by the booster node may be applied to terminals in the connected state. In this case, access of the terminal in the inactive state or idle state to the corresponding network node may be restricted. The access restriction to the terminal in the inactive or idle state may be performed by using baring information of system information or by transmitting only SSBs (e.g., non-cell defining SSBs (non-CD-SSBs)) not associated with SIB1 or RMSI. All terminals and/or terminal groups providing a service for improving the NES performance of the booster node may apply the same parameters. In other words, the booster node may equally apply a start and release of the transmission-off operation for the NES operation, and/or configuration parameters of DTX cycles to all terminals providing services or in units of terminal groups.

In the NES operation method described above, the performing of the NES operation for the terminals in the connected state according to FIG. 3 may be excluded for radio resources indicated by at least one index among indexes (e.g., execution unit identification information or index for a base station, cell, radio access point, BWP, frequency (or transmission carrier), antenna, and/or transmission beam) for distinguishing an NES operation execution unit of at least one network node or a specific network node among network nodes. For example, when the NES operation is performed on a radio access point, at least one radio access points among radio access points providing services to the terminal may not perform the NES operation. Alternatively, when the NES operation is performed on an antenna basis, at least one antenna among antennas configured to provide services to the corresponding terminal (e.g., one MIMO layer, one antenna port, and/or one antenna) may not perform the NES operation.

In addition, when the above-described NES operation is applied, a different priority may be given to the cell, transmission carrier (or frequency), and/or radio access point to which the NES function is applied or performing the NES operation in the cell (re)selection procedure performed by the terminal in the inactive state and/or idle state.

In other words, the terminal in the inactive state and/or idle state may set a priority of the cell, transmission carrier (or frequency), and/or radio access point to which the NES function is applied or performing the NES operation to a lower priority in the cell (re)selection procedure according to configuration of the network, terminal, and/or user. In this case, the terminal may camp by preferentially selecting a cell, transmission carrier (or frequency), and/or radio access point to which the NES function is not applied or not performing the NES operation. On the other hand, the terminal in the inactive state and/or idle state may set a priority of the cell, transmission carrier (or frequency), and/or radio access point to which the NES function is applied or performing the NES operation to a higher priority in the cell (re)selection procedure according to configuration of the network, terminal, and/or user. In this case, the terminal may camp by preferentially selecting a cell, transmission carrier (or frequency), and/or radio access point to which the NES function is applied or performing the NES operation.

The terminal in the inactive state may remain within the coverage of the network node performing the NES operation according to the above-described method. In this case, the configuration information configured by the network node performing the NES operation to the terminal in the inactive state may be maintained or released. For example, the network node may release the configuration parameters within an RRC context (or AS context) of the inactive state terminal. Here, the configuration parameters within the RRC context may mean configuration parameters for a resume procedure, SPS radio resources, CG radio resources, and/or contention-free random access radio resources.

When the network node starts the NES operation according to an operation condition of the mobile communication network, RRC configuration parameters configured for the terminal in the inactive state may be released. However, even when the network node performs the NES operation according to other operation conditions of the mobile communication network (or control of the network node), RRC configuration parameters configured for the terminal in the inactive state may be maintained. Maintaining the RRC configuration parameters may mean that when the network node stops performing the NES operation, the terminal in the inactive state may use the RRC parameters or radio resources configured before performing the NES operation. The network node may transmit indicator (or control information) on whether the terminal in the inactive state can release or maintain (or store) and use the RRC configuration parameters to the terminal using system information and/or a dedicated control message.

With respect to the operation of the timer defined or described in the present disclosure, although operations such as start, stop, reset, restart, or expire of the defined timer are not separately described, they mean or include the operations of the corresponding timer or a counter for the corresponding timer.

In addition, the terminal in the present disclosure may refer to a terminal, an access terminal, a mobile terminal, a station, a subscriber station, a mobile station, a portable subscriber station, a node, a device), an Internet of Thing (IoT) device, or a mounted apparatus (e.g., a mounted module/device/terminal or an on-board device/terminal), like the user equipment (UE) described in FIG. 1.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a base station, comprising:
transmitting discontinuous transmission (DTX) configuration information for a DTX operation to a terminal;
transmitting discontinuous reception (DRX) configuration information for a DRX operation to the terminal; and
transmitting information indicating activation of at least one of the DTX operation and the DRX operation to the terminal,
wherein the DTX operation and the DRX operation are configured separately.

2. The method according to claim 1, wherein the DTX configuration information includes at least one of information on a cycle of the DTX operation, configuration information of an on-duration of the DTX operation, information indicating a time at which the DTX operation starts, information on a timer for performing the DTX operation, allocation information of an uplink channel configured for reception from the terminal during performing the DTX operation, or information indicating a time at which the DTX operation is released.

3. The method according to claim 1, wherein the DRX configuration information includes at least one of information on a cycle of the DRX operation, configuration information of an on-duration of the DRX operation, information indicating a time at which the DRX operation starts, information on a timer for performing the DRX operation, allocation information of an uplink channel configured for reception from the terminal during performing the DRX operation, or information indicating a time at which the DRX operation is released.

4. The method according to claim 1, wherein the DTX configuration information and the DRX configuration information are included in a radio resource control (RRC) message(s) transmitted to the terminal.

5. The method according to claim 1, wherein the information indicating activation is included in a medium access control (MAC) control element (CE) or downlink control information (DCI) transmitted to the terminal.

6. The method according to claim 5, wherein the MAC CE or the DCI further includes information on a start time of the DTX operation or information on a start time of the DRX operation.

7. The method according to claim 6, wherein the start time of each of the DTX operation and the DRX operation is set in units of frames, slots, mini-slots, or symbols.

8. The method according to claim 6, wherein the information on the start time of the DTX operation is an offset between a reception time of the information indicating activation of the DTX operation and the start time of the DTX operation, and the information on the start time of the DRX operation is an offset between a reception time of the information indicating activation of the DRX operation and the start time of the DRX operation.

9. The method according to claim 1, further comprising: transmitting information indicating deactivation of at least one of an activated DTX operation or an activated DRX operation to the terminal, wherein the information indicating deactivation is included in a MAC CE or DCI transmitted to the terminal.

10. The method according to claim 1, further comprising: identifying a state of a service coverage of the base station where the terminal is located, wherein at least one of the DTX operation or the DRX operation, which is activated for the terminal, is determined based on the state of the service coverage.

11. The method according to claim 10, wherein the state of the service coverage is identified as at least one of a number of terminals located in the service coverage or a quality of a service provided to the terminals within the service coverage.

12. The method according to claim 10, further comprising:
re-identifying a state of the service coverage; and
transmitting information indicating deactivation of at least one of an activated DTX operation and an activated DRX operation to the terminal based on the re-identified state of the service coverage.

13. The method according to claim 1, further comprising: transmitting a message including camping restriction information, wherein the camping restriction information indicates whether the base station supports a network energy saving (NES) function, and when the base station supports the NES function, the base station performs at least one of the DTX operation or the DRX operation.

14. The method according to claim 13, further comprising: restricting camping of at least one terminal when the at least one terminal satisfying the camping restriction information requests camping.

15. A method of a terminal, comprising:
receiving discontinuous transmission (DTX) configuration information for a DTX operation from a base station;
receiving discontinuous reception (DRX) configuration information for a DRX operation from the base station; and
receiving information indicating activation of at least one of the DTX operation and the DRX operation from the base station,
wherein the DTX operation and the DRX operation are configured separately.

16. The method according to claim 15, wherein the DTX configuration information includes at least one of information on a cycle of the DTX operation, configuration information of an on-duration of the DTX operation, information indicating a time at which the DTX operation starts, information on a timer for performing the DTX operation, allocation information of an uplink channel configured for transmission to the base station during performing the DTX operation, or information indicating a time at which the DTX operation is released.

17. The method according to claim 15, wherein the DRX configuration information includes at least one of information on a cycle of the DRX operation, configuration information of an on-duration of the DRX operation, information indicating a time at which the DRX operation starts, information on a timer for performing the DRX operation, allocation information of an uplink channel configured for transmission to the base station during performing the DRX operation, or information indicating a time at which the DRX operation is released.

18. The method according to claim 15, wherein the DTX configuration information and the DRX configuration information are included in a radio resource control (RRC) message(s) received from the base station.

19. The method according to claim 15, wherein the information indicating activation is included in a medium access control (MAC) control element (CE) or downlink control information (DCI) transmitted to the terminal.
